(19) United States
(12) Patent Application Publication
(10) Pub. No.: US 2026/0254291 A1
(43) Pub. Date: Aug. 27, 2026

(54) CORE PIECE, STATOR CORE, STATOR, AND ROTATING ELECTRIC MACHINE

(71) Applicants: Sumitomo Electric Industries, Ltd., Osaka-shi, Osaka (JP); Sumitomo Electric Sintered Alloy, Ltd., Takahashi-shi, Okayama (JP)

(72) Inventors: Daichi AZUMA, Osaka-shi, Osaka (JP); Tatsuya SAITO, Osaka-shi, Osaka (JP)

(73) Assignees: Sumitomo Electric Industries, Ltd., Osaka-shi, Osaka (JP); Sumitomo Electric Sintered Alloy, Ltd., Takahashi-shi, Okayama (JP)

(21) Appl. No.: 18/995,499

(22) PCT Filed: Jul. 19, 2023
(86) PCT No.: PCT/JP2023/026374

§ 371 Date: Jan. 16, 2025

(30) Foreign Application Priority Data
Jul. 21, 2022 (JP) 2022-116664

(51) Int. Cl. H02K 1/14

(52) U.S. Cl. CPC H02K 1/148

(57) ABSTRACT

A core piece is included in a stator core for an axial-gap-type rotating electric machine. The core piece includes a first member having a column shape, the first member extending in a direction along an axis of the stator core. A peripheral surface of the first member has a plurality of grooves in at least part of a surface in contact with a winding of a coil. The plurality of grooves being provided along a direction of winding the winding.

### TECHNICAL FIELD

The present disclosure is related to a core piece, a stator core, a stator, and a rotating electric machine.

The present disclosure claims priority based on Japanese Patent Application No. 2022-116664 filed in Japan Patent Office on Jul. 21, 2022, the entire contents of which are incorporated herein by reference.

### BACKGROUND ART

Patent Literatures 1 to 3 each disclose a stator core and a stator for an axial-gap-type motor. The stator core includes teeth, a yoke portion, and flange portions. The stator includes coils each disposed on a tooth included in the stator core. The coil is made by winding a winding around the tooth. Generally, a peripheral surface of the tooth on which the coil is disposed is a flat surface.

### CITATION LIST

### Patent Literature

PTL 1: Japanese Unexamined Patent Application Publication No. 2009-44829

PTL 2: Japanese Unexamined Patent Application Publication No. 2009-124794

PTL 3: Japanese Unexamined Patent Application Publication No. 2009-142095

### SUMMARY OF INVENTION

A core piece according to the present disclosure is
a core piece included in a stator core for an axial-gap-type rotating electric machine.

The core piece includes
a first member that has a column shape and extends in a direction along an axis of the stator core.

A peripheral surface of the first member has a plurality of grooves in at least part of a surface in contact with a winding of a coil. The plurality of grooves are provided along a direction in which the winding is wound.

### BRIEF DESCRIPTION OF DRAWINGSS

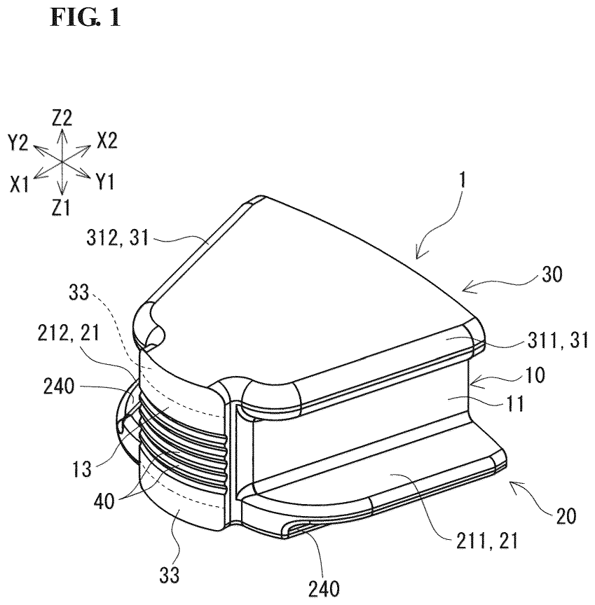

FIG. 1 is a perspective view illustrating an overview of a core piece according to Embodiment 1.

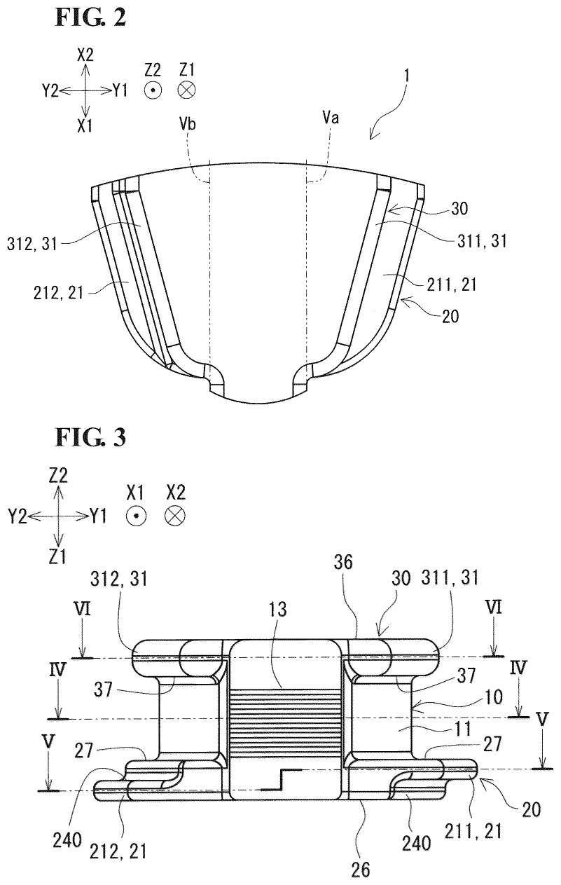

FIG. 2 is a top view illustrating an overview of the core piece according to Embodiment 1.

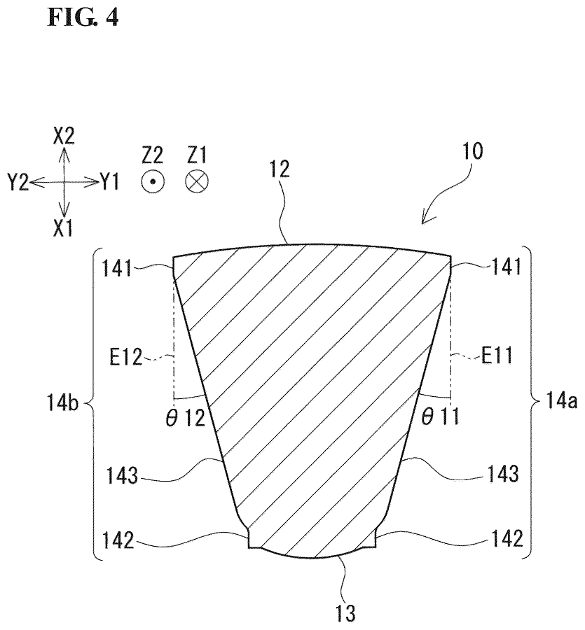

FIG. 3 illustrates the core piece according to Embodiment 1 seen from an inner peripheral surface side.

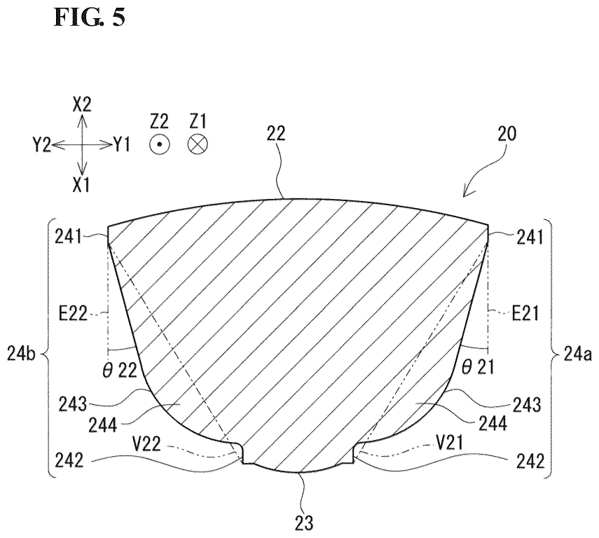

FIG. 4 is a sectional view of the core piece taken along line IV-IV illustrated in FIG. 3.

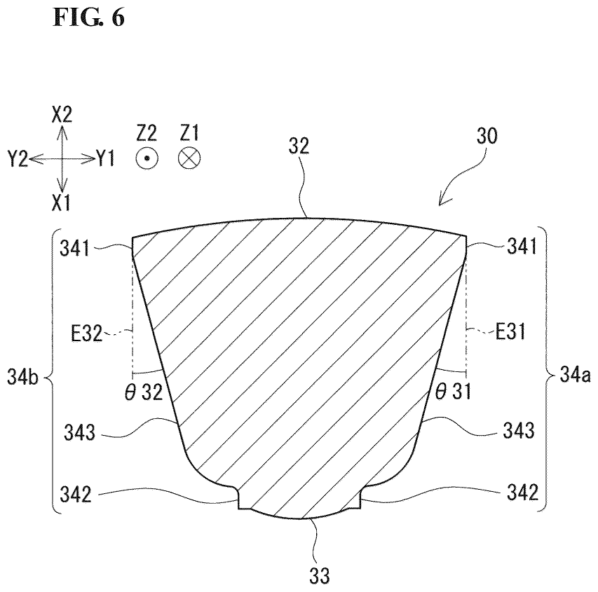

FIG. 5 is a sectional view of the core piece taken along line V-V illustrated in FIG. 3.

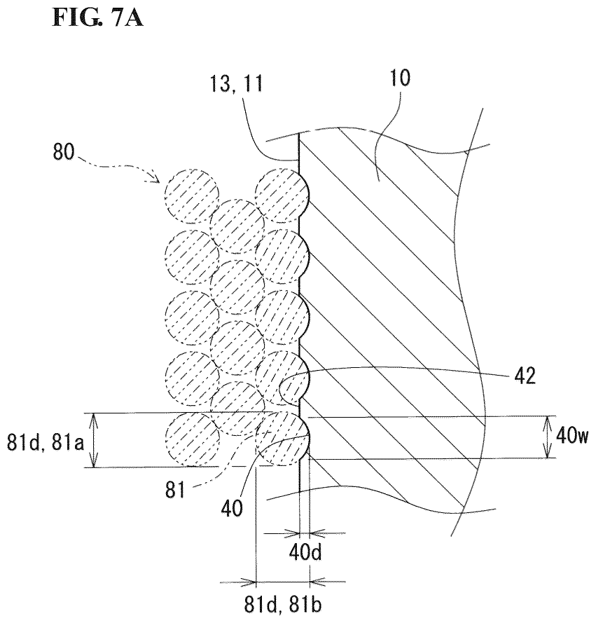

FIG. 6 is a sectional view of the core piece taken along line VI-VI illustrated in FIG. 3.

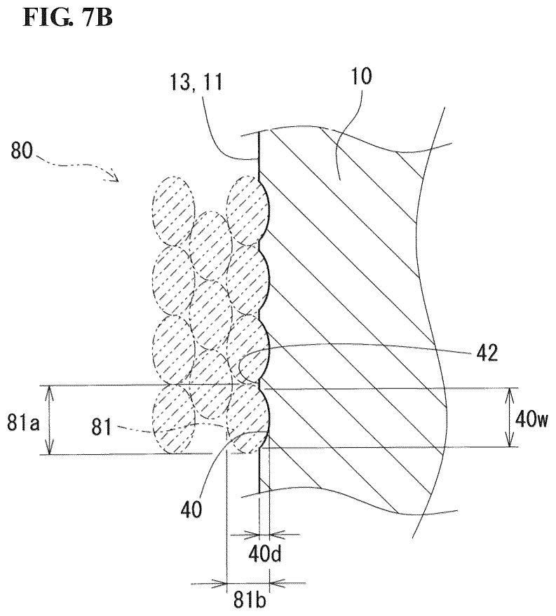

FIG. 7A is a schematic sectional view illustrating a plurality of grooves provided in an inner peripheral surface of a first member in the core piece according to Embodiment 1.

FIG. 7B is a schematic sectional view illustrating an example which is a modification of Embodiment 1 and in which the section of a winding has an elliptical shape.

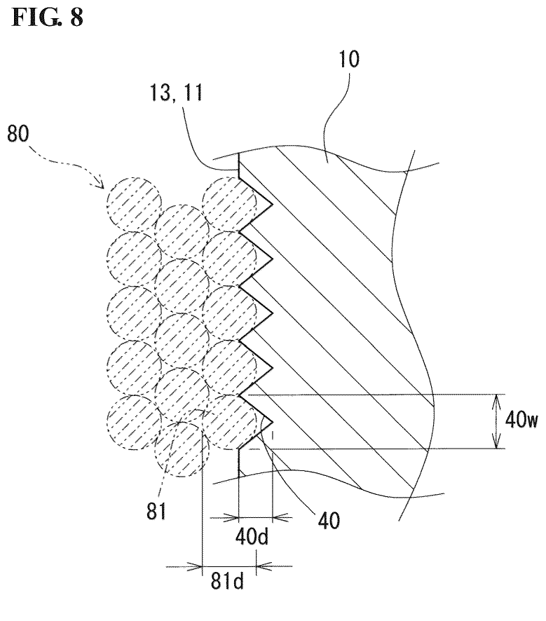

FIG. 8 is a schematic sectional view of a modification of Embodiment 1, illustrating another example of a plurality of grooves.

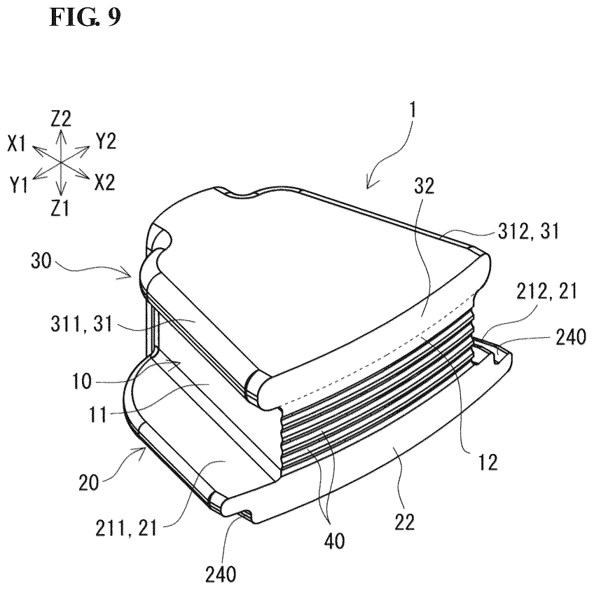

FIG. 9 is a perspective view of another modification of Embodiment 1, illustrating an overview of a core piece having a plurality of grooves in an outer peripheral surface of the first member.

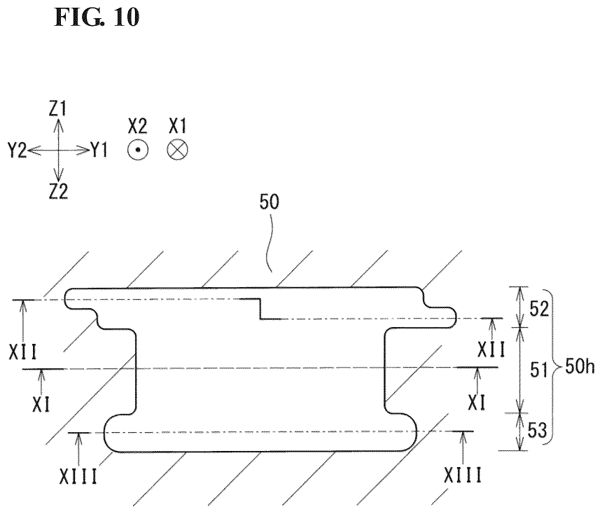

FIG. 10 is a top view illustrating an opening edge of a die of a mold for manufacturing the core piece according to Embodiment 1.

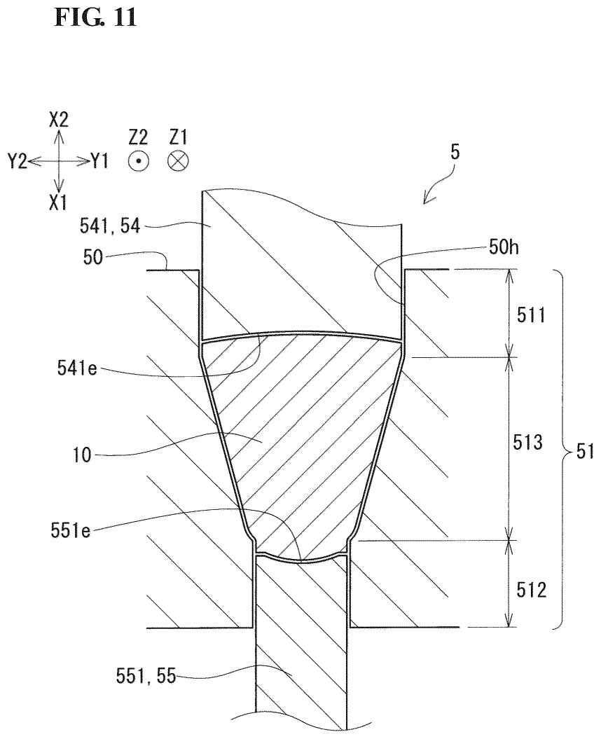

FIG. 11 is a sectional view illustrating an overview of the mold for manufacturing the first member in the core piece according to Embodiment 1.

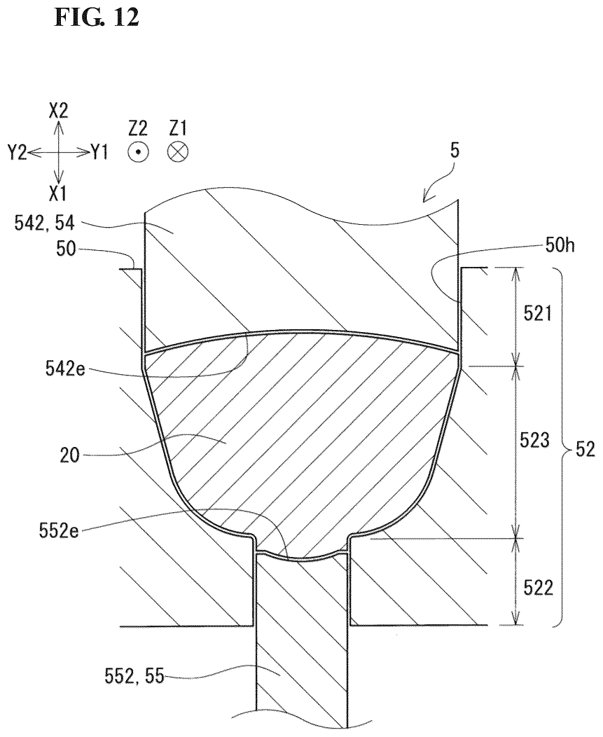

FIG. 12 is a sectional view illustrating an overview of the mold for manufacturing a second member in the core piece according to Embodiment 1.

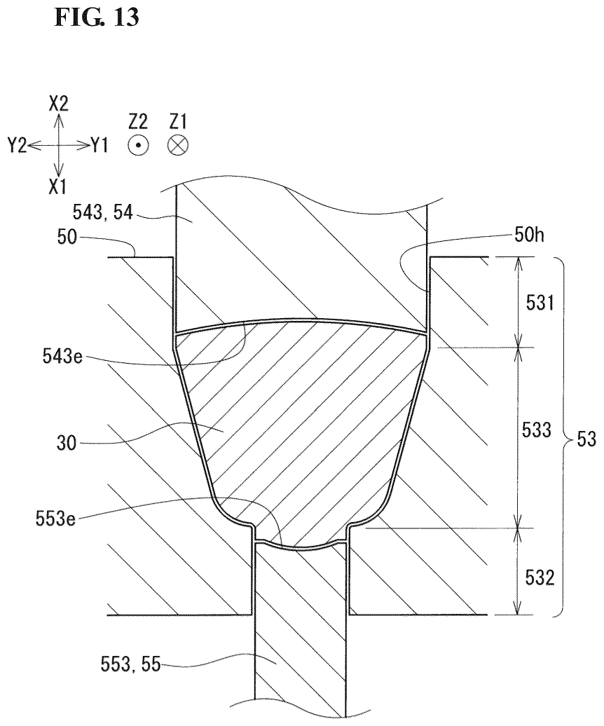

FIG. 13 is a sectional view illustrating an overview of the mold for manufacturing a third member in the core piece according to Embodiment 1.

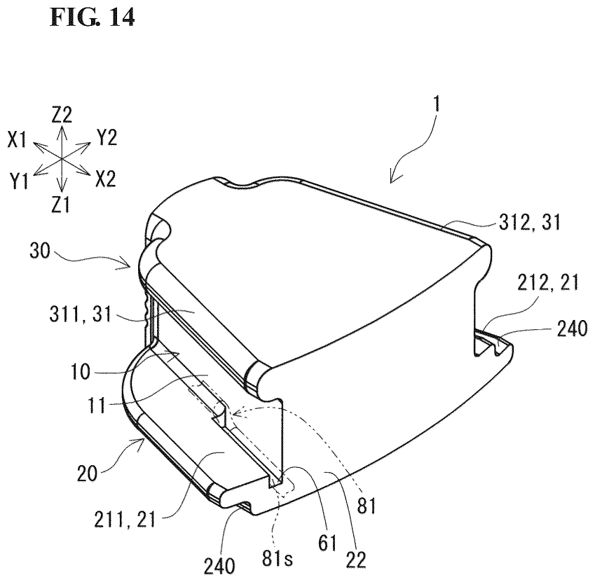

FIG. 14 is a perspective view of another modification of Embodiment 1, illustrating an overview of a core piece having a groove in which a winding-start end portion of the winding is disposed in a projection of the second member.

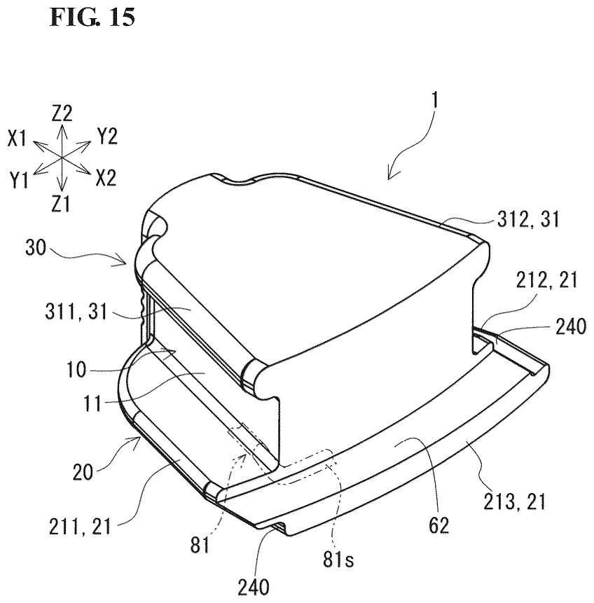

FIG. 15 is a perspective view of another modification of Embodiment 1, illustrating an overview of a core piece having a step in which the winding-start end portion of the winding is disposed in the projection of the second member.

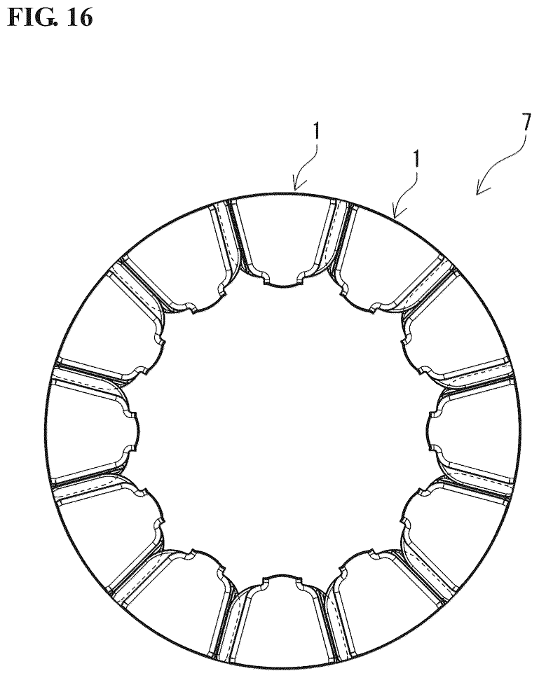

FIG. 16 is a perspective view illustrating an overview of a stator core according to Embodiment 2.

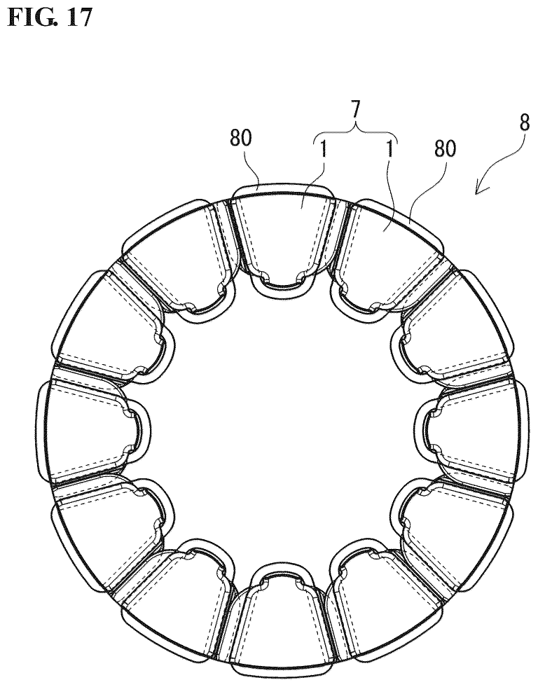

FIG. 17 is a perspective view illustrating an overview of a stator according to Embodiment 3.

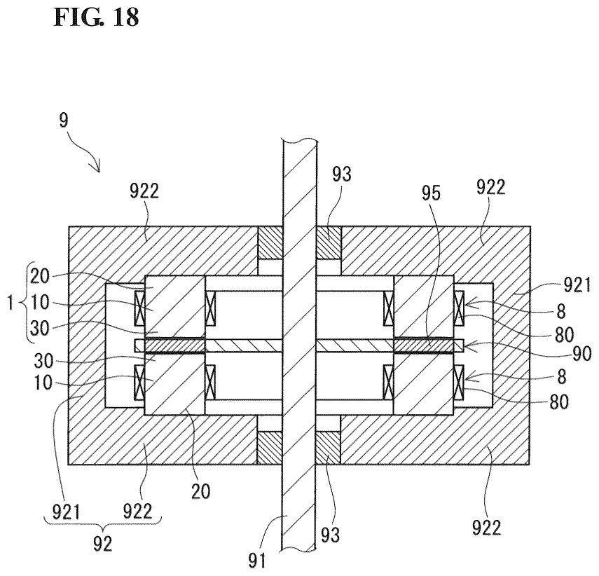

FIG. 18 is a sectional view illustrating an overview of a rotating electric machine according to Embodiment 4.

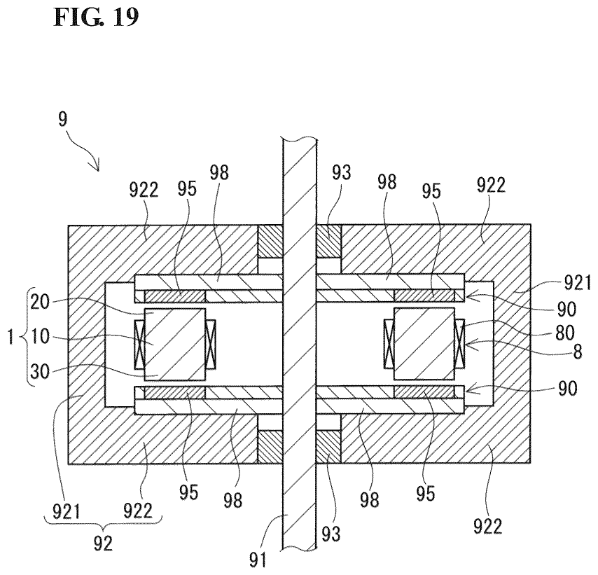

FIG. 19 is a sectional view illustrating an overview of a rotating electric machine according to Embodiment 5.

### DETAILED DESCRIPTION

### Problems to be Solved by Present Disclosure

When a motor is driven, a current flows through a coil. This causes the coil to generate heat. When the size of the motor is reduced while output of the motor is maintained, an increase in the current flowing through the coil is necessary. Since the amount of heat generated by the coil increases, temperature rise of the coil is desirably suppressed.

One of the objects of the present disclosure is to provide a core piece that can suppress the temperature rise of the coil. One of the other objects of the present disclosure is to provide a stator core, a stator, and a rotating electric machine that can suppress the temperature rise of the coil.

### Advantageous Effects of Present Disclosure

The core piece according to the present disclosure can suppress the temperature rise of the coil.

### Description of Embodiments of Present Disclosure

First, embodiments of the present disclosure are listed and described.

(1) A core piece according to an embodiment of the present disclosure is
a core piece included in a stator core for an axial-gap-type rotating electric machine. The core piece includes
a first member that has a column shape and extends in a direction along an axis of the stator core.

A peripheral surface of the first member has a plurality of grooves in at least part of a surface in contact with a winding of a coil. The plurality of grooves are provided along a direction in which the winding is wound.

The core piece according to the present disclosure can suppress temperature rise of the coil. In the core piece according to the present disclosure, the coil is disposed in the first member. The peripheral surface of the first member has the plurality of grooves.

The winding is disposed so as to be fitted in the grooves. Accordingly, compared to a case where the peripheral surface of the first member is a flat surface, a contact area between the winding and the first member increases. As a result of improvement of heat dissipation from the winding to the first member, the coil can be effectively cooled.

Furthermore, when the winding is being wound on the first member, the winding is held in the grooves. Thus, deformation of the winding can be suppressed. Uniformly winding the winding along the grooves improves the space factor of the coil. The improvement of the space factor of the coil is effective for reducing the size and increasing output of the rotating electric machine.

(2) In the core piece according to (1) described above,
a width of each of the plurality of grooves may be ¼ of a long diameter of the winding to the long diameter, and
a depth of each of the plurality of grooves may be ¼ of a short diameter of the winding to the short diameter.

In the core piece according to (2) described above, the winding is sufficiently held when the winding is fitted in the grooves.

(3) In the core piece according to (1) or (2) described above,
a section of the winding may have a circular shape,
a section of each of the plurality of grooves may have an arc shape, and
a radius of a circle of the section of the winding and a radius of an arc of the section of the groove may be identical to each other.

The core piece according to (3) described above facilitates ensuring of a sufficient contact area between the winding and the first member. The reason for this is that a sectional shape of the grooves corresponds to a sectional shape of the winding.

(4) In the core piece according to any one of (1) to (3) described above,
the plurality of grooves may include a coupling surface between two of the grooves adjacent to each other. This coupling surface is continuous with inner peripheral surfaces of the grooves.

The coupling surface may be a flat surface or a rounded curved surface.

In the core piece according to (4) described above, when the coupling surface is the flat surface or the curved surface, the coupling surface does not have a pointed shape.

Thus, chipping is unlikely to occur in the coupling surface.

(5) In the core piece according to any one of (1) to (4) described above,
the peripheral surface may include
   an inner peripheral surface disposed at a position close to the axis of the stator core and
   an outer peripheral surface disposed at a position far from the axis of the stator core.

The plurality of grooves may be provided in at least one of the inner peripheral surface and the outer peripheral surface.

When the plurality of grooves are provided in at least one of the inner peripheral surface and the outer peripheral surface of the first member, the core piece according to (5) described above can suppress the temperature rise of the coil. Particularly, since inner peripheral surfaces of this core piece and another core piece adjacent to this core piece are close to each other along a circumference of the stator core, heat of the coil is likely to accumulate in the inner peripheral surface of the core piece. That is, the temperature rise is large in the winding in contact with the inner peripheral surface of the first member. Thus, when the plurality of grooves are provided in the inner peripheral surface of the first member, the temperature rise of the coil can be more effectively suppressed. In the core piece, the length along the circumference of the axis of the stator core is larger in the outer peripheral surface than in the inner peripheral surface. Thus, when the plurality of grooves are provided in the outer peripheral surface of the first member, stable holding of the winding in each groove is facilitated.

(6) The core piece according to any one of (1) to (5) described above may further include
a second member that has a plate shape and is provided at a first end portion in the direction along the axis in the first member and
a third member that has a plate shape and is provided at a second end portion in the direction along the axis in the first member.

The peripheral surface of the first member may be continuous with the second member and the third member,
the second member may have a projection projecting outward relative to the peripheral surface of the first member, and
the third member may have a projection projecting outward relative to the peripheral surface of the first member.

The first member, the second member, and the third member may include an integrally molded green compact.

The core piece according to (6) described above includes the projection of the second member and the projection of the third member at the respective end portions of the first member. Thus, the core piece can hold the coil disposed in the first member between two projections. Furthermore, since the core piece according to (6) described above includes the green compact obtained by integrally molding the first member, the second member, and the third member, the manufacture of the core piece and handling of the core piece as a single member are facilitated.

(7) In the core piece according to (6) described above,
the projection of the second member or the projection of the third member may have a groove or a step where a winding-start end portion of the winding is disposed.

In the core piece according to (7) described above, the winding-start end portion of the winding is disposed in the above-described groove or the step. Thus, in winding the winding through multilayered winding, interference of the winding of the second layer and further with the winding-start end portion can be avoided. Thus, compared to a core piece without the groove or the step, the number of turns of the winding can be increased by one in the core piece according to (7) described above. That is, the space factor of the coil is improved.

(8) A core piece according to an embodiment of the present disclosure is
a core piece included in a stator core for an axial-gap-type rotating electric machine. The core piece includes
a first member that has a column shape and extends in a direction along an axis of the stator core,
a second member that has a plate shape and is provided at a first end portion in the direction along the axis in the first member, and
a third member that has a plate shape and is provided at a second end portion in the direction along the axis in the first member.

The first member has a peripheral surface continuous with the second member and the third member,
the second member has a projection projecting outward relative to the peripheral surface of the first member, and
the third member has a projection projecting outward relative to the peripheral surface of the first member.

The first member, the second member, and the third member include an integrally molded green compact.

The peripheral surface of the first member includes
an inner peripheral surface disposed at a position close to the axis of the stator core and
an outer peripheral surface disposed at a position far from the axis of the stator core.

In at least one of the inner peripheral surface and the outer peripheral surface, a plurality of grooves are provided in at least a part of a surface in contact with a winding of a coil. The plurality of grooves are provided along a direction of winding the winding.

A width of each of the plurality of grooves is ¼ of a long diameter of the winding to the long diameter,
a depth of each of the plurality of grooves is ¼ of a short diameter of the winding to the short diameter, and
the projection of the second member or the projection of the third member has a groove or a step where a winding-start end portion of the winding is disposed.

The core piece according to (8) described above includes the configurations having been described in (1), (2), (5), (6) and (7). The core piece according to (8) described above produces the effects produced by the above-described configurations.

(9) A stator core according to an embodiment of the present disclosure is
for an axial-gap-type rotating electric machine and includes
a plurality of core pieces disposed in an annular shape.

Each of the plurality of core pieces is the core piece according to any one of (1) to (8) described above.

Since the stator core according to the present disclosure includes the above-described core piece, the stator core can suppress the temperature rise of the coil.

(10) A stator according to an embodiment of the present disclosure is
for an axial-gap-type rotating electric machine and includes
the stator core according to (9) described above, and
a coil disposed in each of the first members in the stator core,

Since the stator according to the present disclosure includes the above-described stator core, the stator can suppress the temperature rise of the coil.

(11) A rotating electric machine according to an embodiment of the present disclosure is an axial-gap-type rotating electric machine and includes
a rotor and a stator. The rotor and the stator are disposed so as to face each other in a direction along an axis.

The stator is the stator according to (10) described above.

Since the rotating electric machine according to the present disclosure includes the above-described stator, the rotating electric machine can suppress the temperature rise of the coil.

### Details of Embodiments of Present Disclosure

The details of embodiments according to the present disclosure will be described below with reference to the drawings. The same reference numerals in the drawings denote parts of the same names.

### Embodiment 1

### Core

A core piece 1 according to Embodiment 1 is described with reference to FIGS. 1 to 9. As will be described later with reference to FIG. 16, a stator core 7 is configured such that a plurality of core pieces 1 are disposed in an annular shape. As will be described later with reference to FIG. 17, the stator core 7 is included in a stator 8 by disposing a coil 80 at a first member 10 in each core piece 1. As will be described later with reference to FIGS. 18 and 19, the stator 8 is used for an axial gap-type rotating electric machine 9. As illustrated in FIG. 1, the core piece 1 according to the present embodiment includes the first member 10 having a column shape. The first member 10 extends in a direction along the axis of the stator core 7. One of the features of the core piece 1 according to the present embodiment is that a plurality of grooves 40 are provided in an peripheral surface 11 of the first member 10. As will be described later with reference to FIG. 7A, a winding 81 of the coil 80 is wound along the grooves 40. Hereinafter, a direction along the axis of the stator core may be referred to as an “axial direction”, a direction perpendicular to the axial direction of the stator core may be referred to as a “radial direction”, and a direction along a circumference of the axis of the stator core may be referred to as a “circumferential direction”.

Furthermore, as illustrated in FIG. 1, the core piece 1 according to the present embodiment includes a plate-shaped second member 20 and a plate-shaped third member 30. The second member 20 is provided at a first end portion in the first member 10 in the axial direction. The third member 30 is provided at a second end portion in the first member 10 in the axial direction.

Hereinafter, the details of the core piece 1 are described.

A direction along the radial direction of the stator core 7 in the core piece 1 is defined as an X-axis direction.

A direction along the axial direction of the stator core 7 in the core piece 1 is defined as a Z-axis direction.

A direction perpendicular to both the X-axis direction and the Z-axis direction of the core piece 1 is defined as a Y-axis direction.

In the X-axis direction, a direction approaching the axis of the stator core 7 in the core piece 1 is defined as an X1 direction, and a direction separating from the axis of the stator core 7 in the core piece 1 is defined as an X2 direction.

The X1 direction is an inner circumferential direction of the stator core 7.

The X2 direction is an outer circumferential direction of the stator core 7.

In the Z-axis direction, a direction extending from the third member 30 toward the second member 20 in the first member 10 is defined as a Z1 direction, and a direction extending from the second member 20 toward the third member 30 in the first member 10 is defined as a Z2 direction.

An end portion of the first member 10 in the Z1 direction is the first end portion of the first member 10.

An end portion of the first member 10 in the Z2 direction is the second end portion of the first member 10.

In the Y-axis direction, a first direction of the stator core 7 in the core piece 1 is defined as a Y1 direction, and a second direction of the stator core 7 in the core piece 1 is defined as a Y2 direction.

### First Member

The first member 10 has a column shape extending in the Z-axis direction. The first member 10 is included in a tooth in both of the following cases: the core piece 1 is included in the stator core 7 for an axial-gap-type rotating electric machine 9 in a double-stator single-rotor form; and the core piece 1 is included in the stator core 7 for an axial-gap-type rotating electric machine 9 in a single-stator double-rotor form. As illustrated in FIG. 18, in the axial-gap-type rotating electric machine 9 in the double-stator single-rotor form, a single rotor 90 is mounted so as to be interposed between two stators 8. As illustrated in FIG. 19, in the axial-gap-type rotating electric machine 9 in the single-stator double-rotor form, a single stator 8 is mounted so as to be interposed between two rotors 90. Hereinafter, for convenience of description, the double-stator single-rotor may be referred to as DS/SR and the single-stator double-rotor may be referred to as SS/DR.

The first member 10 may have, for example, a square column shape or a circular column shape. The square column shape is, for example, a quadrangular column shape in which a section taken along a plane perpendicular to the Z-axis direction is a quadrangle. The quadrangular column shape is, for example, a trapezoidal column shape in which the above-described sectional shape is a trapezoidal shape. The above-described section may be uniform or nonuniform in the Z-axis direction. The term “trapezoidal shape” refers not only to a geometrical trapezoid but also to any of a range of shapes considered to be substantially a trapezoid including a shape having rounded corners as in the present example. The “trapezoidal shape” refers not only to a trapezoid having legs of equal length such as isosceles trapezoidal shape but also to a trapezoid having legs of different length such as a right trapezoidal shape. This feature is also applied to the second member 20 and the third member 30 in a similar or same manner, which will be described later.

As illustrated in FIGS. 1 and 4, the first member 10 according to the present embodiment has a trapezoidal column shape in which the above-described sectional shape is a trapezoidal shape. In the above-described sectional shape, the length of a side positioned in the X2 direction is large and the length of a side positioned in the X1 direction is small. The above-described sectional shape of the first member 10 is uniform in the Z-axis direction. When the first member 10 has a trapezoidal column shape, ensuring of a large sectional area is facilitated. In addition, reduction of a dead space in the core piece 1 and a configuration of the stator 8 having a high space factor are facilitated.

As illustrated in FIGS. 1 and 3, the first member 10 has the peripheral surface 11 continuous with the second member 20 and the third member 30. As illustrated in FIG. 4, this peripheral surface 11 of the first member 10 has an outer peripheral surface 12, an inner peripheral surface 13, a first side surface 14a, and a second side surface 14b. The outer peripheral surface 12 is positioned in the X2 direction. That is, the outer peripheral surface 12 is disposed at a position far from the axis of the stator core 7. The inner peripheral surface 13 is positioned in the X1 direction. That is, the inner peripheral surface 13 is disposed at a position close to the axis of the stator core 7. The first side surface 14a and the second side surface 14b are positioned on respective sides of the core piece 1 that are separated from each other in the circumferential direction of the stator core 7. That is, the first side surface 14a is positioned in the first direction of the circumferential direction of the stator core 7 in the core piece 1. The second side surface 14b is positioned in the second direction of the circumferential direction of the stator core 7 in the core piece 1. The positional relationships among the outer peripheral surface 12, the inner peripheral surface 13, the first side surface 14a, and the second side surface 14b are also applied to the second member 20 and the third member 30 in a similar or same manner, which will be described later.

The outer peripheral surface 12 is continuous with an outer peripheral edge of the first side surface 14a and an outer peripheral edge of the second side surface 14b. The inner peripheral surface 13 is continuous with an inner peripheral edge of the first side surface 14a and an inner peripheral edge of the second side surface 14b. That is, the first side surface 14a and the second side surface 14b are continuous with the outer peripheral surface 12 and the inner peripheral surface 13.

The length between the first side surface 14a and the second side surface 14b on the outer peripheral surface 12, that is, the length of the outer peripheral surface 12 in the Y-axis direction is larger than the length between the first side surface 14a and the second side surface 14b on the inner peripheral surface 13, that is, the length of the inner peripheral surface 13 in the Y-axis direction. According to the present embodiment, the outer peripheral surface 12 has a curved surface convex in the X2 direction. The outer peripheral surface 12 may be a flat surface. According to the present embodiment, the inner peripheral surface 13 has a curved surface convex in the X1 direction. The inner peripheral surface 13 may have a curved surface convex in the X2 direction or may be a flat surface. The bending radii of the outer peripheral surface 12 and the inner peripheral surface 13 may be the same as or different from each other.

Each of the first side surface 14a and the second side surface 14b has a first parallel surface 141, a second parallel surface 142, and a first inclined surface 143. The first parallel surfaces 141 of the first side surface 14a and the second side surface 14b are parallel to each other. The second parallel surfaces 142 of the first side surface 14a and the second side surface 14b are parallel to each other. The first parallel surface 141 of the first side surface 14a and the second parallel surface 142 of the first side surface 14a are parallel to each other. The first parallel surfaces 141 and the second parallel surfaces 142 are parallel to the X-axis direction in the core piece 1. The X-axis direction refers to a direction extending along a straight line that passes through the center of the stator core 7 and divides the core piece 1 into two equal parts in the circumferential direction of the stator core 7. The first parallel surfaces 141 are continuous with the outer peripheral surface 12. The second parallel surfaces 142 are continuous with the inner peripheral surface 13. The first inclined surfaces 143 are continuous with the respective first parallel surfaces 141 and the respective second parallel surfaces 142.

Although it depends on the size of the core piece 1, the length of the first parallel surfaces 141 and the length of the second parallel surfaces 142 in the X-axis direction are preferably, for example, 0.3 mm to 25 mm. When these lengths are the above-described lower limit value or larger, damage to a mold 5 due to contact between a lower punch 55 and a die 50, which will be described later with reference to FIGS. 10 and 12, can be suppressed. Although a method of manufacturing the core piece 1 will be described later, the reason for this is that, when these lengths are the lower limit value or larger, pressure can be sufficiently applied to raw material powder to be formed into the core piece 1. When these lengths are the above-described upper limit value or smaller, the sectional area of the first member 10 can be increased. Thus, improvement of torque and suppression of an iron loss can be achieved in the axial-gap-type rotating electric machine 9. The length of the first parallel surfaces 141 and the length of the second parallel surface 142 in the X-axis direction are more preferably 0.4 mm to 20 mm and particularly preferably 0.5 mm to 15 mm. The above-described preferable range of the length of the first parallel surface 141 and the length of the second parallel surface 142 in the X-axis direction in each of the first side surface 14a and the second side surface 14b of the first member 10 is also applied, in a similar or same manner, to first parallel surfaces 241 and second parallel surfaces 242 of a first side surface 24a and a second side surface 24b of the second member 20, which will be described later, and first parallel surfaces 341 and second parallel surfaces 342 of a first side surface 34a and a second side surface 34b of the third member 30, which will be described later.

As illustrated in FIG. 4, a first inclination angle θ11 and a second inclination angle θ12 of the first inclined surfaces 143 are preferably, for example, 5° to 20°. When the first inclination angle 011 and the second inclination angle θ12 are 5° to 20°, winding of the winding 81, which will be described later, on the peripheral surface 11 of the first member 10 is facilitated. The first inclination angle θ11 and the second inclination angle θ12 are more preferably 5.5° to 18° and particularly preferably 6° to 16°. Although the first inclination angle θ11 and the second inclination angle θ12 are preferably the same, the first inclination angle θ11 and the second inclination angle θ12 may be different from each other. The first inclination angle θ1 refers to an angle formed between an extended plane E11 of the first parallel surface 141 and the first inclined surface 143 in the first side surface 14a. The second inclination angle θ12 refers to an angle formed between an extended plane E12 of the first parallel surface 141 and the first inclined surface 143 in the second side surface 14b.

### Grooves

As illustrated in FIG. 1, the peripheral surface 11 of the first member 10 has the plurality of grooves 40. As illustrated in FIG. 7A, it is sufficient that the plurality of grooves 40 be provided in at least part of the surface in contact with the winding 81 of the coil 80. The above-described “at least part of the surface in contact with the winding 81 of the coil 80” includes corner portions of two surfaces adjacent to each other in the peripheral surface 11. According to the present embodiment, the plurality of grooves 40 are provided in the inner peripheral surface 13 of the peripheral surface 11. The grooves 40 are provided along a direction in which the winding 81 of the coil 80 is wound.

Hereinafter, the direction in which the winding 81 is wound may be referred to as a “winding direction”. FIG. 7A is a sectional view of the inner peripheral surface 13 taken along a plane that is perpendicular to the inner peripheral surface 13 and parallel to the Z-axis direction. The plurality of grooves 40 are arranged in the Z-axis direction. Each groove 40 extends in a direction perpendicular to the Z-axis direction on the inner peripheral surface 13. The direction in which the grooves 40 extend is a direction along the winding direction of the winding 81 and may be inclined relative to the Z-axis direction. The winding 81 is disposed so as to be fitted in the grooves 40. An increase in contact area between the winding 81 and the first member 10 improves the heat dissipation from the winding 81 to the first member 10. As a result, the coil 80 is effectively cooled, and a temperature rise of the coil 80 is suppressed.

The section of the winding 81 has, for example, a circular shape or an elliptical shape. According to the present embodiment, the section of the winding 81 has a circular shape. The section of the winding 81 is a section taken along a plane perpendicular to a direction along the length of the winding 81. The winding 81 includes a copper wire and insulation coating coated over the copper wire. The coil 80 is a multilayered wound coil formed by winding in an aligned manner the winding 81 in multilayer. The winding 81 has a long diameter Sla and a short diameter 81b. The long diameter 81a is the maximum diameter in the section of the winding 81. The short diameter 81b is the maximum diameter of the diameter perpendicular to the long diameter 81a. When the section of the winding 81 has a circular shape, each of the long diameter 81a and the short diameter 81b is equal to a diameter 81d.

The sectional shape of the grooves 40 may be any shape as long as the winding 81 is in contact with an inner peripheral surface of each groove 40 at two or more points. The section of the grooves 40 according to the present embodiment has an arc shape as illustrated in FIG. 7A. The section of the grooves 40 is a section taken along a plane perpendicular to an extending direction of the grooves 40. Inner peripheral surfaces of the grooves 40 are arc surfaces. According to the present embodiment, the radius of the circle of the section of the winding 81 and the radius of the arc of the section of the grooves 40 are the same. That is, the sectional shape of the grooves 40 corresponds to the sectional shape of the winding 81. When the winding 81 is substantially in close contact with the inner peripheral surfaces of the grooves 40, ensuring of a sufficient contact area between the winding 81 and the first member 10 is facilitated.

It is sufficient that the grooves 40 have a size that can accommodate the winding 81. When the section of the winding 81 is circular, a width 40w of the grooves 40 is, for example, ¼ of the diameter 81d of the winding 81 to the diameter 81d. The width 40w is an opening width of the grooves 40 that is open in the peripheral surface 11. When the width 40w is ¼ of the diameter 81d to the diameter 81d, sufficient holding of the winding 81 is facilitated. The width 40w may be ½ of the diameter 81d to the diameter 81d. Furthermore, the width 40w may be ⅗ of the diameter 81d to ⅘ of the diameter 81d. As a depth 40d of the grooves 40 increases, sufficient holding of the winding 81 fitted in the grooves 40 is facilitated. The depth 40d of the grooves 40 can be determined so as to facilitate accommodation of the winding 81 in the grooves 40 depending on the width 40w of the grooves 40. The depth 40d of the grooves 40 is, for example, ¼ of the diameter 81d of the winding 81 to the diameter 81d. The depth 40d is a distance from an opening edge to the bottom of the grooves 40. When the depth 40 d is ¼ of the diameter 81d to the diameter 81d, sufficient holding of the winding 81 is facilitated. Furthermore, the depth 40d may be ⅓ of the diameter 81d to ½ of the diameter 81d.

In the first member 10 illustrated in FIG. 7A, the diameter of the winding 81 and the diameter of the grooves 40 are the same. That is, the section of the grooves 40 is formed to have an arc shape along the circular shape of the winding 81. An outer peripheral surface of the winding 81 matches the inner peripheral surfaces of the grooves 40, and the contact area between the winding 81 and the grooves 40 becomes the largest relative to the width 40w. When these relationships are expressed in ranges, the width 40w and the depth 40d of the grooves 40 may satisfy the following relationship (1) or relationship (2) relative to the diameter 81d of the winding 81. Herein, the diameter 81d is simply described as “D”.
(1) When the width 40w is 0.25D to D, the depth 40d is 0.016D to 0.5D.
(2) When the width 40w is 0.6D to 0.8D, the depth 40 d is 0.1D to 0.2D.

According to the present embodiment, the plurality of grooves 40 have coupling surfaces 42 between two adjacent grooves 40. The coupling surfaces 42 are continuous with the inner peripheral surfaces of the grooves 40. As illustrated in FIG. 7A, the coupling surfaces 42 according to the present embodiment are flat surfaces. When the coupling surfaces 42 are flat surfaces, no pointed corner portion is formed between the grooves 40 adjacent to each other. When the coupling surfaces 42 do not have a pointed shape, chipping is unlikely to occur in the coupling surfaces 42. Furthermore, even when the winding 81 is brought into contact with the coupling surfaces 42 while the winding 81 is being wound on the first member 10, damage to the winding 81 can be suppressed. Furthermore, comer portions between the inner peripheral surfaces of the grooves 40 and the coupling surfaces 42 may be rounded. The coupling surfaces 42 may be rounded curved surfaces. Even when the coupling surfaces 42 are the above-described curved surfaces, the coupling surfaces 42 do not have a pointed shape. Thus, chipping is unlikely to occur in the coupling surfaces 42. Furthermore, damage to the winding 81 can be suppressed while the winding 81 is being wound on the first member 10.

As illustrated in FIG. 7B, the section of the winding 81 may have an elliptical shape. When the section of the winding 81 has an elliptical shape, the winding 81 is wound so that, for example, the long diameter 81a is parallel to the peripheral surface 11. The section of the grooves 40 has the shape that conforms to the elliptical shape of the winding 81. The width 40w of the grooves 40 is, for example, ¼ of the long diameter 81a of the winding 81 to the long diameter 81a of the winding 81. The width 40w may be ⅗ of the long diameter 81a to ⅘ of the long diameter 81a. The depth 40d of the grooves 40 is, for example, ¼ of the short diameter 81b of the winding 81 to the short diameter 81b of the winding 81. Furthermore, the depth 40d may be ⅓ of the short diameter 81b to ½ of the short diameter 81b. Unlike the example illustrated in FIG. 7B, the winding 81 may be wound such that, for example, the short diameter 81b is parallel to the peripheral surface 11. That is, the winding 81 may be configured such that the long diameter 81a and the short diameter 81b illustrated in FIG. 7B are interchanged. In this case, the width 40w of the grooves 40 may be ¼ of the short diameter 81b of the winding 81 to the short diameter 81b of the winding 81, and the depth 40d of the grooves 40 may be ¼ of the long diameter 81a of the winding 81 to the long diameter 81a of the winding 81.

As illustrated in FIG. 8, the section of the grooves 40 may have a triangular shape. An inner peripheral surface of each triangular grooves 40 includes two linear inclined surfaces. The winding 81 is in contact with the inner peripheral surface of the groove 40 at two points.

It is sufficient that the plurality of grooves 40 be provided in any of the outer peripheral surface 12, the inner peripheral surface 13, the first side surface 14a, and the second side surface 14b illustrated in FIG. 4 out of the peripheral surface 11. For example, as illustrated in FIG. 9, the plurality of grooves 40 may be provided in the outer peripheral surface 12. Furthermore, the plurality of grooves 40 may be provided in both the inner peripheral surface 13 and the outer peripheral surface 12. The plurality of grooves 40 may be provided in a corner portion between two adjacent surfaces. For example, the plurality of grooves 40 may be provided in the proximity including the corner portion between the inner peripheral surface 13 and at least one of the first side surface 14a and the second side surface 14b. Furthermore, the plurality of grooves 40 may be provided in the proximity including the corner portion between the outer peripheral surface 12 and at least one of the first side surface 14a and the second side surface 14b.

When the plurality of the grooves 40 are provided in the inner peripheral surface 13, the grooves 40 can be molded with the lower punch 55, which will be described later with reference to FIG. 12. When the plurality of the grooves 40 are provided in the outer peripheral surface 12, the grooves 40 can be molded with an upper punch 54, which will be described later with reference to FIG. 11. When the plurality of the grooves 40 are provided in at least one of the first side surface 14a and the second side surface 14b, the grooves 40 can be molded with an inner peripheral surface of a mold hole 50h of the die 50, which will be described later with reference to FIG. 10. When the plurality of the grooves 40 are provided in at least one of the first side surface 14a and the second side surface 14b, the grooves 40 may be damaged due to rubbing of the grooves 40 against the inner peripheral surface of the mold hole 50h during removal of the core piece 1 from the mold hole 50h of the die 50. Furthermore, since frictional resistance between the core piece 1 and the inner peripheral surface of the mold hole 50h increases, ease of removing the core piece 1 from the mold hole 50h reduces. When the plurality of grooves 40 are provided in the inner peripheral surface 13, the grooves 40 are molded with the lower punch 55. Thus, the grooves 40 are unlikely to be damaged. When the plurality of grooves 40 are provided in the outer peripheral surface 12, the grooves 40 are molded with the upper punch 54. Thus, the grooves 40 are unlikely to be damaged.

### Second Member

As illustrated in FIGS. 1 and 3, the second member 20 is a plate-shaped member provided at the first end portion of the first member 10 in the Z-axis direction. The second member 20 is included in a yoke when the core piece 1 is included in the stator core 7 for the axial-gap-type rotating electric machine 9 in the DS/SR form. The second member 20 is included in a flange portion when the core piece 1 is included in the stator core 7 for the axial-gap-type rotating electric machine 9 in the SS/DR form.

According to the present embodiment, the second member 20 has a trapezoidal shape. Regarding the trapezoidal shape, the sectional shape of the second member 20 taken along a plane perpendicular to the Z-axis direction is trapezoidal. The above-described section may be uniform or nonuniform in the Z-axis direction. The second member 20 may have a rectangular plate shape when the core piece 1 is included in the stator core 7 for the axial-gap-type rotating electric machine 9 in the SS/DR form.

As illustrated in FIGS. 1 to 3, the second member 20 has a projection 21. The projection 21 projects outward relative to the peripheral surface 11 of the first member 10. The projection 21 may project outward relative to the peripheral surface 11 of the first member 10 in part of the peripheral surface 11 of the first member 10 or may project outward relative to the peripheral surface 11 of the first member 10 entirely in the peripheral direction of the first member 10. According to the present embodiment, the projection 21 has a first projection 211 and a second projection 212. The first projection 211 projects in the second direction of the circumferential direction of the stator core 7. The second projection 212 projects in the second direction of the circumferential direction of the stator core 7. The projection 21 may have a projecting part projecting in the X1 direction and a projecting part projecting in the X2 direction instead of the first projection 211 and the second projection 212. The projection 21 may have the projecting part projecting in the X1 direction and the projecting part projecting in the X2 direction in addition to the first projection 211 and the second projection 212. In this case, the projection 21 is provided in an annular shape along the peripheral direction of the first member 10.

Projecting lengths of the first projection 211 and the second projection 212 of the second member 20 are larger than projecting lengths of a first projection 311 and a second projection 312 of the third member 30, which will be described later, when the core piece 1 is included in the stator core 7 for the axial-gap-type rotating electric machine 9 in the DS/SR form. The projecting lengths of the first projection 211 and the second projection 212 of the second member 20 may be the same as the projecting lengths of the first projection 311 and the second projection 312 of the third member 30 when the core piece 1 is included in the stator core 7 for the axial-gap-type rotating electric machine 9 in the SS/DR form. The projecting lengths each refer to a length of projection in a direction perpendicular to the peripheral surface 11 of the first member 10. When the peripheral surface 11 bas a curved surface, the projection length refers to a length along the normal direction of the curved surface.

As illustrated in FIG. 3, the second member 20 has a first end surface 26 and a second end surface 27. As illustrated in FIG. 5, the second member 20 has an outer peripheral surface 22, an inner peripheral surface 23, the first side surface 24a, and the second side surface 24b. As has been described, the positional relationships among the outer peripheral surface 22, the inner peripheral surface 23, the first side surface 24a, and the second side surface 24b are the same as or similar to the positional relationships among the surfaces in the first member 10. The first end surface 26 and the second end surface 27 are disposed at positions where the first end surface 26 and the second end surface 27 face each other. The first end surface 26 is positioned in the Z1 direction. The first end surface 26 is positioned on a side opposite from the first member 10. The second end surface 27 is positioned in the Z2 direction. The second end surface 27 is positioned on the first member 10 side. The positional relationship between the first end surface 26 and the second end surface 27 is the same as or similar to that in the third member 30, which will be described later.

The outer peripheral surface 22 is continuous with an outer peripheral edge of the first side surface 24a, an outer peripheral edge of the second side surface 24b, an outer peripheral edge of the first end surface 26 (see FIG. 3), and an outer peripheral edge of the second end surface 27 (see FIG. 3). The outer peripheral surface 22 of the second member 20 is continuous with the outer peripheral surface 12 of the first member 10 (see FIG. 4). The inner peripheral surface 23 is continuous with an inner peripheral edge of the first side surface 24a, an inner peripheral edge of the second side surface 24b, an inner peripheral edge of the first end surface 26, and an inner peripheral edge of the second end surface 27. The inner peripheral surface 23 of the second member 20 is continuous with the inner peripheral surface 13 of the first member 10 (see FIG. 4). The first side surface 24a and the second side surface 24b are continuous with the outer peripheral surface 22 and the inner peripheral surface 23. The first end surface 26 is continuous with the outer peripheral surface 22, the first side surface 24a, the second side surface 24b, and the inner peripheral surface 23. The second end surface 27 is continuous with the outer peripheral surface 22, the first side surface 24a, the second side surface 24b, and the inner peripheral surface 23. The second end surface 27 is also continuous with the peripheral surface 11 of the first member 10.

The length between the first side surface 24a and the second side surface 24b on the outer peripheral surface 22 is larger than the length between the first side surface 24a and the second side surface 24b on the inner peripheral surface 23. The length between the first side surface 24a and the second side surface 24b on the outer peripheral surface 22 of the second member 20 is larger than the length between the first side surface 14a and the second side surface 14b on the outer peripheral surface 12 of the first member 10. The length between the first side surface 24a and the second side surface 24b on the inner peripheral surface 23 of the second member 20 is the same as the length between the first side surface 14a and the second side surface 14b on the inner peripheral surface 13 of the first member 10.

According to the present embodiment, the outer peripheral surface 22 has a curved surface convex in the X2 direction. The outer peripheral surface 22 may be a flat surface. According to the present embodiment, the inner peripheral surface 23 has a curved surface convex in the X1 direction. The inner peripheral surface 23 may have a curved surface convex in the X2 direction or may be a flat surface. The bending radii of the outer peripheral surface 22 and the inner peripheral surface 23 may be the same as or different from each other.

Each of the first side surface 24a and the second side surface 24b has a first parallel surface 241, a second parallel surface 242, and a first inclined surface 243. The first parallel surfaces 241 of the first side surface 24a and the second side surface 24b are parallel to each other. The second parallel surfaces 242 of the first side surface 24a and the second side surface 24b are parallel to each other. The first parallel surface 241 of the first side surface 24a and the second parallel surface 242 of the first side surface 24a are parallel to each other. The first parallel surfaces 241 and the second parallel surfaces 242 are parallel to the X-axis direction of the core piece 1. The first parallel surfaces 241 are continuous with the outer peripheral surface 22. The second parallel surfaces 242 are continuous with the inner peripheral surface 23. The first inclined surfaces 243 are continuous with the respective first parallel surfaces 241 and the respective second parallel surfaces 242.

As illustrated in FIG. 5, a first inclination angle θ21 and a second inclination angle θ22 of the first inclined surfaces 243 are preferably, for example, 5° to 20°. When the first inclination angle θ21 and the second inclination angle θ22 are 5° to 20°, disposition of the core piece 1 in an annular shape and a configuration of the stator core 7 are facilitated. The first inclination angle θ21 and the second inclination angle θ22 are more preferably 5.5° to 18° and particularly preferably 60 to 16°. Although the first inclination angle 021 and the second inclination angle θ22 are preferably the same, the first inclination angle θ21 and the second inclination angle θ22 may be different from each other. The first inclination angle θ21 refers to an angle formed between an extended plane E21 of the first parallel surface 241 and the first inclined surface 243 in the first side surface 24a. The second inclination angle θ22 refers to an angle formed between an extended plane E22 of the first parallel surface 241 and the first inclined surface 243 in the second side surface 24b.

When the core pieces 1 are included in the stator core 7 for the axial-gap-type rotating electric machine 9 in the DS/SR form, regarding a first core piece 1 and a second core piece 1 adjacent to each other in the circumferential direction of the stator core 7, the first side surface 24a of the second member 20 of the first core piece 1 and the second side surface 24b of the second member 20 of the second core piece 1 are in contact with each other. In this case, the first inclined surface 243 of the first side surface 24a preferably has a projecting part 244 projecting outward relative to a first virtual plane V21. The first inclined surface 243 of the second side surface 24b preferably has a projecting part 244 projecting outward relative to a second virtual plane V22.

The first virtual plane V21 is a plane connecting a first connecting portion and a second connecting portion to each other in the first side surface 24a of the first projection 211. The first connecting portion in the first side surface 24a is a connecting portion where the first parallel surface 241 of the first side surface 24a and the first inclined surface 243 of the first side surface 24a are connected to each other. The second connecting portion in the first side surface 24a is a connecting portion where the second parallel surface 242 of the first side surface 24a and the inner peripheral surface 23 are connected to each other. The second virtual plane V22 is a plane connecting a first connecting portion and a second connecting portion to each other in the second side surface 24b of the second projection 212. The first connecting portion in the second side surface 24b is a connecting portion where the first parallel surface 241 of the second side surface 24b and the first inclined surface 243 of the second side surface 24b are connected to each other. The second connecting portion in the second side surface 24b is a connecting portion where the second parallel surface 242 of the second side surface 24b and the inner peripheral surface 23 are connected to each other. The first virtual plane V21 and the second virtual plane V22 are represented by two-dot chain lines extending in inclined directions in the page of FIG. 5.

The first inclined surface 243 has the projecting part 244 in each of the first side surface 24a and the second side surface 24b. This facilitates an increase in a magnetic path area of the stator core 7. The reason for this is as follows. For example, in the case of the core pieces in each of which the first side surface 24a and the second side surface 24b each have the first parallel surface 241, the second parallel surface 242, and the first inclined surface 243, and the first inclined surface 243 has no projecting part 244, the following situation occurs. In disposing these core pieces in an annular shape, when it is attempted to bring the first side surface 24a of a first core piece and the second side surface 24b of a second core piece, which are adjacent to each other in the circumferential direction of the stator core 7, into contact with each other, a first corner portion of the first core piece and a second comer portion of the second core piece are brought into contact with each other. The first comer portion is a corner portion between the first side surface 24a and the inner peripheral surface 23. The second corner portion is a comer portion between the second side surface 24b and the inner peripheral surface 23. Thus, sufficient contact is not achieved between the first side surface 24a of the first core piece 1 and the second side surface 24b of the second core piece. That is, the contact area between the first side surface 24a of the first core piece 1 and the second side surface 24b of the second core piece reduces.

In contrast, in the above-described core piece 1, the first side surface 24a has the first parallel surface 241, the second parallel surface 242, and the first inclined surfaces 243, and the first inclined surface 243 has the projecting part 244 projecting relative to the first virtual plane V21. Furthermore, in the above-described core piece 1, the second side surface 24b has the first parallel surface 241, the second parallel surface 242, and the first inclined surfaces 243, and the first inclined surface 243 has the projecting part 244 projecting relative to the second virtual plane V22. In disposing the core pieces 1 in an annular shape, even when the first side surface 24a of the first core piece 1 and the second side surface 24b of the second core piece 1 are brought into contact with each other, contact between the first corner portion of a first core piece 1 and the second corner portion of a second core piece 1 can be prevented. Thus, the first side surface 24a of the first core piece 1 and the second side surface 24b of the second core piece 1 can be sufficiently in contact with each other. That is, the contact area between the first side surface 24a of the first core piece 1 and the second side surface 24b of the second core piece 1 increases.

When the core pieces 1 are included in the stator core 7 for the axial-gap-type rotating electric machine 9 in the DS/SR form, as described above, regarding the first core piece 1 and the second core piece 1 adjacent to each other in the circumferential direction of the stator core 7, the first side surface 24a of the second member 20 of the first core piece 1 and the second side surface 24b of the second member 20 of the second core piece 1 are in contact with each other. In this case, as illustrated in FIG. 3, the first side surface 24a and the second side surface 24b of the core piece 1 preferably have respective steps 240 which can be engaged with each other. In this way, the increase in the magnetic path area of the stator core 7 is facilitated. The first core piece 1 and the second core piece 1 adjacent to each other in the circumferential direction of the stator core 7 can be engaged with each other by using the step 240 of the first side surface 24a of the first projection 211 in the second member 20 of the first core piece 1 and the step 240 of the second side surface 24b of the second projection 212 in the second member 20 of the second core piece 1. Thus, the first core piece 1 and the second core piece 1 can be in sufficient contact with each other. This can increase the contact area between the core pieces 1 adjacent to each other in the circumferential direction of the stator core 7. The step 240 of the first side surface 24a is provided on the first end surface 26 side. The step 240 of the first side surface 24a is configured such that the distance between the step 240 and the first side surface 14a of the first member 10 increases from the first end surface 26 toward the second end surface 27. The step 240 of the second side surface 24b is provided on the second end surface 27 side. The step 240 of the second side surface 24b is configured such that the distance between the step 240 and the second side surface 14b of the first member 10 increases from the second end surface 27 toward the first end surface 26.

Although it is not illustrated, the first side surface 24a of the core piece 1 may have at least one of a recess portion and a protrusion instead of the step. The second side surface 24b may have at least one of a protrusion corresponding to the recess of the first side surface 24a and a recess corresponding to the protrusion of the first side surface 24a. That is, each of the first side surface 24a and the second side surface 24b may have a recess or a protrusion. One of the first side surface 24a and the second side surface 24b may have only the protrusion, and the other side surface may have only the recess. Neither the number nor the shape of recesses and protrusions is particularly limited.

Although it is not illustrated, the first side surface 24a and the second side surface 24b of the core piece 1 may have respective second inclined surfaces to be in contact with each other instead of the step, the recess, and the protrusion. For example, the second inclined surface of the first side surface 24a may incline outward from the first end surface 26 toward the second end surface 27. The second inclined surface of the second side surface 24b may incline outward from the second end surface 27 toward the first end surface 26.

When the core pieces 1 are included in the stator core 7 for the axial-gap-type rotating electric machine 9 in the SS/DR form, the core pieces 1 are disposed in an annular shape while the core pieces 1 are not in contact with each other. In this case, the first side surface 24a or the second side surface 24b does not necessarily have any of the step 240, the recess, the protrusion, and the second inclined surface which are engaged with each other.

A corner portion between the first side surface 24a and the first end surface 26 and a corner portion between the first side surface 24a and the second end surface 27 are rounded. A corner portion between the second side surface 24b and the first end surface 26 and a corner portion between the second side surface 24b and the second end surface 27 are rounded.

The first end surface 26 is, for example, a flat plane when the core piece 1 is included in the stator core 7 for the axial-gap-type rotating electric machine 9 in the DS/SR form. The first end surface 26 may be a flat plane or convex toward the Z1 direction when the core piece 1 is included in the stator core 7 for the axial-gap-type rotating electric machine 9 in the SS/DR form. With such a core piece 1, an axial-gap-type rotating electric machine 9 with low noise and low vibration can be configured. The reason for this is as follows. As illustrated in FIG. 19, in the axial-gap-type rotating electric machine 9 in the SS/DR form, the stator 8 and each rotor 90 are disposed so as to face each other. As illustrated in FIG. 17, the stator 8 includes the stator core 7 and coils 80. As illustrated in FIG. 16, the stator core 7 is configured such that a plurality of core pieces 1 are disposed in an annular shape. As illustrated in FIG. 17, the coils 80 are each disposed in the first member 10 of a corresponding one of the core pieces 1 (see FIG. 1). When the first end surface 26 of the second member 20 of the core piece 1 has a convex shape, a steep change of the magnetic flux of magnets 95 of the rotors 90 received by the core piece 1 is likely to be suppressed in the axial-gap-type rotating electric machine 9 illustrated in FIG. 19. Thus, cogging torque is likely to be reduced. When the cogging torque is reduced, neither noise nor vibration is likely to increase.

A corner portion between the first end surface 26 and the inner peripheral surface 23 and a comer portion between the first end surface 26 and the outer peripheral surface 22 are preferably chamfered. These comer portions are unlikely to be damaged when chamfered. Instead of being chamfered, these corner portions may be rounded.

### Third Member

As illustrated in FIGS. 1 and 3, the third member 30 is a plate-shaped member provided at the second end portion of the first member 10 in the Z-axis direction. The third member 30 is included in the flange portion in both of the following cases: the core piece 1 is included in the stator core 7 for the axial-gap-type rotating electric machines 9 in the DS/SR form; and the core piece 1 is included in the stator core 7 for the axial-gap-type rotating electric machines 9 in the SS/DR form.

According to the present embodiment, the third member 30 has a trapezoidal shape. Regarding the trapezoidal shape, the sectional shape of the third member 30 taken along a plane perpendicular to the Z-axis direction is trapezoidal. The above-described section may be uniform or nonuniform in the Z-axis direction. The third member 30 may have a rectangular shape. For example, the shapes of the members of the core piece 1 may be as follows: the first member 10 has a trapezoidal column shape and at least one of the second member 20 and the third member 30 has a rectangular shape.

As illustrated in FIGS. 1 to 3, the third member 30 has a projection 31. The projection 31 projects outward relative to the peripheral surface 11 of the first member 10. The projection 31 may project outward relative to the peripheral surface 11 of the first member 10 in part of the peripheral surface 11 of the first member 10 or may project outward relative to the peripheral surface 11 of the first member 10 entirely in the peripheral direction of the first member 10. According to the present embodiment, the projection 31 has the first projection 311 and the second projection 312. The first projection 311 projects in the first direction of the circumferential direction of the stator core 7. The second projection 312 projects in the second direction of the circumferential direction of the stator core 7. The projection 31 may have at least one of a projecting part projecting in the X1 direction and a projecting part projecting in the X2 direction instead of the first projection 311 and the second projection 312. The projection 31 may have the projecting part projecting in the X1 direction and the projecting part projecting in the X2 direction in addition to the first projection 311 and the second projection 312. In this case, the projection 31 is provided in an annular shape along the peripheral direction of the first member 10.

As described above, projecting lengths of the first projection 311 and the second projection 312 of the third member 30 are smaller than the projecting lengths of the first projection 211 and the second projection 212 of the second member 20 when the core piece 1 is included in the stator core 7 for the axial-gap-type rotating electric machine 9 in the DS/SR form. As described above, the projecting lengths of the first projection 311 and the second projection 312 of the third member 30 may be the same as the projecting lengths of the first projection 211 and the second projection 212 of the second member 20 when the core piece 1 is included in the stator core 7 for the axial-gap-type rotating electric machine 9 in the SS/DR form.

As illustrated in FIG. 3. the third member 30 has a first end surface 36 and a second end surface 37. As illustrated in FIG. 6, the third member 30 has an outer peripheral surface 32, an inner peripheral surface 33, the first side surface 34a, and the second side surface 34b. As has been described, the positional relationships among the outer peripheral surface 32, the inner peripheral surface 33, the first side surface 34a, and the second side surface 34b are the same as or similar to the positional relationships among the surfaces in the first member 10. As has been described, the positional relationship between the first end surface 36 and the second end surface 37 is the same as or similar to the positional relationship between the surfaces in the second member 20.

The outer peripheral surface 32 is continuous with an outer peripheral edge of the first side surface 34a, an outer peripheral edge of the second side surface 34b, an outer peripheral edge of the first end surface 36 (see FIG. 3), and an outer peripheral edge of the second end surface 37 (see FIG. 3). The outer peripheral surface 32 of the third member 30 is continuous with the outer peripheral surface 12 of the first member 10 (see FIG. 4). The inner peripheral surface 33 is continuous with an inner peripheral edge of the first side surface 34a, an inner peripheral edge of the second side surface 34b, an inner peripheral edge of the first end surface 36, and an inner peripheral edge of the second end surface 37. The inner peripheral surface 33 of the third member 30 is continuous with the inner peripheral surface 13 of the first member 10 (see FIG. 4). The first side surface 34a and the second side surface 34b are continuous with the outer peripheral surface 32 and the inner peripheral surface 33. The first end surface 36 is continuous with the outer peripheral surface 32, the first side surface 34a, the second side surface 34b, and the inner peripheral surface 33. The second end surface 37 is continuous with the outer peripheral surface 32, the first side surface 34a, the second side surface 34b, and the inner peripheral surface 33. The second end surface 37 is also continuous with the peripheral surface 11 of the first member 10.

The length between the first side surface 34a and the second side surface 34b on the outer peripheral surface 32 is larger than the length between the first side surface 34a and the second side surface 34b on the inner peripheral surface 33. The length between the first side surface 34a and the second side surface 34b on the outer peripheral surface 32 of the third member 30 is larger than the length between the first side surface 14a and the second side surface 14b on the outer peripheral surface 12 of the first member 10. The length between the first side surface 34a and the second side surface 34b on the outer peripheral surface 32 of the third member 30 is smaller than the length between the first side surface 24a and the second side surface 24b on the outer peripheral surface 22 of the second member 20. The length between the first side surface 34a and the second side surface 34b on the inner peripheral surface 33 of the third member 30 is the same as the length between the first side surface 14a and the second side surface 14b on the inner peripheral surface 13 of the first member 10. That is, the length between the first side surface 14a and the second side surface 14b on the inner peripheral surface 13 of the first member 10, the length between the first side surface 24a and the second side surface 24b on the inner peripheral surface 23 of the second member 20, and the length between the first side surface 34a and the second side surface 34b on the inner peripheral surface 33 of the third member 30 are the same as each other.

According to the present embodiment, the outer peripheral surface 32 has a curved surface convex in the X2 direction. The outer peripheral surface 32 may be a flat surface. According to the present embodiment, the inner peripheral surface 33 has a curved surface convex in the X1 direction. The inner peripheral surface 33 may have a curved surface convex in the X2 direction or may be a flat surface. The bending radii of the outer peripheral surface 32 and the inner peripheral surface 33 may be the same or as different from each other.

Out of the outer peripheral surface 12, the outer peripheral surface 22, and the outer peripheral surface 32, the bending radii of at least two outer peripheral surfaces may be the same. Of course, the bending radii of all the outer peripheral surfaces, that is, the outer peripheral surface 12, the outer peripheral surface 22, and the outer peripheral surface 32 may be the same. The bending radii of all the outer peripheral surfaces, that is, the outer peripheral surface 12, the outer peripheral surface 22, and the outer peripheral surface 32 may be different from each other. Out of the inner peripheral surface 13, the inner peripheral surface 23, and the inner peripheral surface 33, the bending radii of at least two inner peripheral surfaces may be the same. Of course, the bending radi of all the inner peripheral surfaces, that is, the inner peripheral surface 13, the inner peripheral surface 23, and the inner peripheral surface 33 may be the same. The bending radii of all the inner peripheral surfaces, that is, the inner peripheral surface 13, the inner peripheral surface 23, and the inner peripheral surface 33 may be different from each other.

Each of the first side surface 34a and the second side surface 34b has a first parallel surface 341, a second parallel surface 342, and a first inclined surface 343. The first parallel surfaces 341 of the first side surface 34a and the second side surface 34b are parallel to each other. The second parallel surfaces 342 of the first side surface 34a and the second side surface 34b are parallel to each other. The first parallel surface 341 of the first side surface 34a and the second parallel surface 342 of the first side surface 34a are parallel to each other. The first parallel surfaces 341 and the second parallel surfaces 342 are parallel to the X-axis direction of the core piece 1. The first parallel surfaces 341 are continuous with the outer peripheral surface 32. The second parallel surfaces 342 are continuous with the inner peripheral surface 33. The first inclined surfaces 343 are continuous with the respective first parallel surfaces 341 and the respective second parallel surfaces 342.

As illustrated in FIG. 6, a first inclination angle θ31 and a second inclination angle θ32 of the first inclined surfaces 343 are preferably, for example, 5° to 20°. When the first inclination angle θ31 and the second inclination angle θ32 are 5° to 20°, variation in density of the core piece 1 can be suppressed. The first inclination angle θ31 and the second inclination angle θ32 are more preferably 5.5° to 18° and particularly preferably 6°to 16°. Although the first inclination angle θ31 and the second inclination angle θ32 are preferably the same, the first inclination angle θ31 and the second inclination angle θ32 may be different from each other. The first inclination angle θ31 refers to an angle formed between an extended plane E31 of the first parallel surface 341 and the first inclined surface 343 in the first side surface 34a. The second inclination angle θ32 refers to an angle formed between an extended plane E32 of the first parallel surface 341 and the first inclined surface 343 in the second side surface 34b.

Out of the first inclination angle 011, the first inclination angle θ21, and the first inclination angle θ31, at least two inclination angles may be the same. Out of the second inclination angle θ12, the second inclination angle θ22, and the second inclination angle θ32, at least two inclination angles may be the same. Of course, all the first inclination angles, that is, the first inclination angle θ11, the first inclination angle θ21, and the first inclination angle θ31 may be the same. Of course, all the second inclination angles, that is, the second inclination angle θ12, the second inclination angle θ22, and the second inclination angle θ32 may be the same. All the first inclination angles, that is, the first inclination angle θ11, the first inclination angle θ21, and the first inclination angle θ31 may be different from each other. All the second inclination angles, that is, the second inclination angle θ12, the second inclination angle θ22, and the second inclination angle θ32 may be different from each other.

A corner portion between the first side surface 34a and the first end surface 36 and a comer portion between the first side surface 34a and the second end surface 37 are rounded. A comer portion between the second side surface 34b and the first end surface 36 and a corner portion between the second side surface 34b and the second end surface 37 are rounded.

The first end surface 36 may be a flat surface as illustrated in FIG. 3 or may have a convex shape in the Z2 direction in both of the following cases: the core piece 1 is included in the stator core 7 for the axial-gap-type rotating electric machines 9 in the DS/SR form; and the core piece 1 is included in the stator core 7 for the axial-gap-type rotating electric machines 9 in the SS/DR form. When the first end surface 36 has a convex shape, an axial-gap-type rotating electric machine 9 with low noise and low vibration can be configured. The reason for this is as follows. As illustrated in FIG. 18 or 19, in the axial-gap-type rotating electric machine 9, the stator 8 and the rotor 90 are disposed so as to face each other. As illustrated in FIG. 17, the stator 8 includes the stator core 7 and coils 80. As illustrated in FIG. 16, the stator core 7 is configured such that a plurality of core pieces 1 are disposed in an annular shape. As illustrated in FIG. 17, the coils 80 are each disposed in the first member 10 of a corresponding one of the core pieces 1. When the first end surface 36 of the third member 30 of the core piece 1 has a convex shape, a steep change of the magnetic flux of the magnets 95 of the rotor 90 received by the core piece 1 is likely to be suppressed in the axial-gap-type rotating electric machine 9 illustrated in FIGS. 18 and 19. Thus, cogging torque is likely to be reduced. When the cogging torque is reduced, neither noise nor vibration is likely to increase.

A corner portion between the first end surface 36 and the inner peripheral surface 33 and a comer portion between the first end surface 36 and the outer peripheral surface 32 are preferably chamfered. These comer portions are unlikely to be damaged when chamfered. Instead of being chamfered, these corner portions may be rounded.

### Joint

As illustrated in FIG. 3, a first joint between the second end surface 27 of the projection 21 of the second member 20 and the peripheral surface 11 of the first member 10 and a second joint between the second end surface 37 of the projection 31 of the third member 30 and the peripheral surface 11 of the first member 10 are rounded. According to the present embodiment, the first joint includes a joint between the first projection 211 of the second member 20 and the peripheral surface 11 of the first member 10 and a joint between the second projection 212 of the second member 20 and the peripheral surface 11 of the first member 10. These joints are rounded. The second joint includes a joint between the first projection 311 of the third member 30 and the peripheral surface 11 of the first member 10 and a joint between the second projection 312 of the third member 30 and the peripheral surface 11 of the first member 10. These joints are rounded. When each of the joints has a rounded shape, the core piece 1 is unlikely to be damaged from the joints as starting points.

The bending radius of the first joint and the bending radius of the second joint are preferably 0.2 mm to 4.0 mm. When the bending radii of the first joint and the second joint are 0.2 mm or larger, load applied to a mold is small in the manufacture of the core piece 1. When the bending radii of the first joint and the second joint are 4.0 mm or smaller, winding of the coil 80 is facilitated in configuring the stator 8, which will be described later with reference to FIG. 17. Thus, an increase in the number of turns of the coil 80 is facilitated. The bending radius of the first joint and the bending radius of the second joint are more preferably 0.3 mm to 3.0 mm and particularly preferably 0.5 mm to 2.0 mm. The bending radius of the first joint and the bending radius of the second joint may be the same as or different from each other.

### Area Ratio

The total area of the outer peripheral surfaces 12, 22, and 32 respectively in the first, second, and the third members 10, 20, and 30 is preferably larger than the total area of the inner peripheral surfaces 13, 23, and 33 respectively in the first, second, and third members 10, 20, and 30 and four times the total area of the inner peripheral surfaces 13, 23, and 33 respectively in the first, second, and third members 10, 20, and 30 or smaller. When the total area of the outer peripheral surfaces 12, 22, and 32 is larger than the total area of the inner peripheral surfaces 13, 23, and 33 in each core piece 1, disposition of the core pieces 1 in an annular shape and the configuration of the stator core 7 are facilitated. The manufacture of the core piece 1 is facilitated when the total area of the outer peripheral surfaces 12, 22, and 32 is four times the total area of the inner peripheral surfaces 13, 23, and 33 or smaller. When the ratio of the total area of the inner peripheral surfaces 13, 23, and 33 is comparatively large, the area pushed out by the lower punch 55 is large during removal of the core piece 1 from the mold 5. Thus, damage to the core piece 1 is likely to be suppressed during the removal of the core piece 1 from the mold 5. The total area of the outer peripheral surfaces 12, 22, and 32 is more preferably 1.2 times to 3.8 times the total area of the inner peripheral surfaces 13, 23, and 33 and particularly preferably 1.5 times to 3.5 times the total area of the inner peripheral surfaces 13, 23, and 33.

The core piece 1 according to the present embodiment includes a green compact obtained by integrally molding the first member 10, the second member 20, and the third member 30. The term “integrally molding” refers to forming of the first member 10, the second member 20, and the third member 30 in a connected manner by molding without, for example, mechanical connection using screws or adhesion using an adhesive. The green compact is composed of a plurality of soft magnetic particles. The green compact is formed of an aggregation of the soft magnetic particles. The green compact is obtained by compression molding soft magnetic powder composed of the plurality of soft magnetic particles. The soft magnetic particles are iron particles consisting of pure iron or an iron-based alloy. The pure iron refers to a substance with a purity of Fe (iron) being 99 mass % or higher. The iron-based alloy includes at least one element out of Si (silicon) and Al (aluminum) and the balance consists of Fe and incidental impurities. The iron-based alloy is, for example, at least one selected from the group consisting of an Fe—Si alloy, an Fe—Al alloy, and an Fe—Si—Al alloy. The Fe—Si alloy is, for example, silicon steel. The Fe—Si—Al alloy is, for example, Sendust. Since the above-described material is comparatively soft, the soft magnetic particles are likely to deform when the green compact is molded. Thus, a core piece 1 is a high-density core piece with high dimensional accuracy. The green compact is preferably formed of the aggregation of the plurality of coated soft magnetic particles having insulation coating on the surfaces of the soft magnetic particles. That is, the green compact is preferably obtained by compression molding the coated soft magnetic powder composed of the plurality of coated soft magnetic particles. When the insulation coating is formed, electrical insulation between the particles is likely to be ensured with the insulation coating. This can reduce an iron loss of the green compact ascribable to an eddy-current loss. The soft magnetic particles are as described above. As the insulation coating, for example, phosphate coating or silica coating is used.

### Relative Density

The relative density of the green compact is preferably 85% or higher. The green compact with a relative density of 85% or higher has good magnetic characteristics such as saturation flux density and good mechanical characteristics such as strength. The relative density of the green compact is more preferably 90% or higher and particularly preferably 93% or higher. The relative density of the green compact may be lower than 100%. The term “relative density” refers to the ratio (%) of the density of an actual green compact to the real density of the soft magnetic particles formed into the green compact.

### Difference in Relative Density

Regarding a first portion, a second portion, and a third portion of the core piece 1, the difference in relative density between the first portion and the third portion and the difference in relative density between the second portion and the third portion are preferably 5.0% or smaller. Since the difference in relative density of the core piece 1 is small, the physical characteristics such as the magnetic characteristics are substantially uniform in the core piece 1. As the difference in relative density between the first portion and the third portion and the difference in relative density between the second portion and the third portion reduce, the difference in relative density is more preferable. The difference in relative density between the first portion and the third portion and the difference in relative density between the second portion and the third portion are more preferably 4.0% or smaller and particularly preferably 3.0% or smaller. Herein, as illustrated in FIG. 2, out of three portions of the core piece 1 divided by a virtual plane Va along the second parallel surface 142 of the first side surface 14a (see FIG. 4) and a virtual plane Vb along the second parallel surface 142 of the second side surface 14b (see FIG. 4), a portion positioned in the first direction of the circumferential direction is defined as the first portion, a portion positioned in the second direction of the circumferential direction is defined as the second portion, and a portion positioned between the first portion and the second portion is defined as the third portion.

Among the first member 10, the second member 20, and the third member 30, the difference in relative density between a member with a highest relative density and a member with a lowest relative density is preferably 5.0% or smaller. Since the difference in the above-described relative density of the core piece 1 is small, the physical characteristics such as the magnetic characteristics are substantially uniform in the core piece 1. As the difference in relative density between a member with a highest relative density and a member with a lowest relative density reduces, the difference in relative density is more preferable. The difference in relative density between a member with a highest relative density and a member with a lowest relative density is more preferably 4.0% or smaller and particularly preferably 3.0% or smaller.

It is preferable that the difference in relative density between the first portion and the third portion and the difference in relative density between the second portion and the third portion be 5.0% or smaller and the difference in relative density between a member with a highest relative density and a member with a lowest relative density be 5.0% or smaller.

### Method of Manufacturing

The core piece 1 according to Embodiment 1 can be manufactured by a method of manufacturing a core piece including a charging step and a molding step. In the charging step, raw material powder is charged into a cavity of the mold 5. In the molding step, the raw material powder in the cavity is subjected to compression molding. First, with reference to FIGS. 10 to 13, the mold 5 is described, and then, each of the steps is described.

### Mold

The mold 5 includes the die 50, the upper punch 54, and the lower punch 55. The cavity into which the raw material powder is charged is formed by the die 50 and the lower punch 55.

### Die

The die 50 has a mold hole 50h. The mold hole 50h is disposed such that the upper punch 54 and the lower punch 55 face each other. An inner peripheral shape of the mold hole 50h corresponds to the shape of the core piece 1. The upper punch 54 can be independently driven relative to the die 50 in an up-down direction. The lower punch 55 can be independently driven relative to the die 50 in the up-down direction.

The mold hole 50h has a first hole portion 51 illustrated in FIGS. 10 and 11, a second hole portion 52 illustrated in FIGS. 10 and 12, and a third hole portion 53 illustrated in FIGS. 10 and 13. FIG. 10 illustrates an opening edge on the upper punch 54 side in the mold hole 50h of the die 50. For convenience of description, the die 50 is hatched in FIG. 10. FIGS. 11 to 13 are sectional views illustrating a state in which the raw material powder charged into the cavity is subjected to compression molding with the upper punch 54 and the lower punch 55. A cutting position of the sectional view illustrated in FIG. 11 corresponds to a position indicated by a cutting line XI-XI illustrated in FIG. 10. A cutting position of the sectional view illustrated in FIG. 12 corresponds to a position indicated by a cutting line XII-XII illustrated in FIG. 10. A cutting position of the sectional view illustrated in FIG. 13 corresponds to a position indicated by a cutting line XIII-XIII illustrated in FIG. 10.

The first hole portion 51 has an inner peripheral surface used to form the first side surface 14a and the second side surface 14b of the first member 10. The second hole portion 52 has an inner peripheral surface used to form the first side surface 24a, the second side surface 24b, the first end surface 26, and the second end surface 27 of the second member 20. The third hole portion 53 has an inner peripheral surface used to form the first side surface 34a, the second side surface 34b, the first end surface 36, and the second end surface 37 of the third member 30. The first hole portion 51, the second hole portion 52, and the third hole portion 53 are formed in a connected manner in a direction perpendicular to a direction in which the upper punch 54 and the lower punch 55 face each other. Specifically, the second hole portion 52 communicates with the first end portion side of the first hole portion 51 in the above-described perpendicular direction. The third hole portion 53 communicates with the second end portion side of the first hole portion 51 in the above-described perpendicular direction.

The first hole portion 51 has a first straight portion 511, a second straight portion 512, and a tapered portion 513. The first straight portion 511, the tapered portion 513, and the second straight portion 512 are formed in a connected manner in order from an upper side from which the upper punch 54 is inserted toward a lower side from which the lower punch 55 is inserted. Likewise, the second hole portion 52 has a first straight portion 521, a second straight portion 522, and a tapered portion 523. The first straight portion 521, the tapered portion 523, and the second straight portion 522 are formed in a connected manner in order from the upper side from which the upper punch 54 is inserted toward the lower side from which the lower punch 55 is inserted. Likewise, the third hole portion 53 has a first straight portion 531, a second straight portion 532, and a tapered portion 533. The first straight portion 531, the tapered portion 533, and the second straight portion 532 are formed in a connected manner in order from the upper side from which the upper punch 54 is inserted toward the lower side from which the lower punch 55 is inserted. The first straight portions 511, 521, and 531 are used to form a part of the core piece 1 near an outer peripheral surface. The second straight portions 512, 522, and 532 are used to form a part of the core piece 1 near an inner peripheral surface. The tapered portions 513, 523, and 533 are used to form a part of the core piece 1 between the outer peripheral surface and the inner peripheral surface.

When the plurality of grooves 40 are formed in the first side surface 14a or the second side surface 14b of the first member 10, it is sufficient that protrusions and recesses corresponding to the plurality of grooves 40 be provided in the inner peripheral surface of the first hole portion 51.

### Upper Punch

The upper punch 54 has a first upper punch portion 541 illustrated in FIG. 11, a second upper punch portion 542 illustrated in FIG. 12, and a third upper punch portion 543 illustrated in FIG. 13. The first upper punch portion 541 has a first lower end surface 541e. The first lower end surface 541e is used to form the outer peripheral surface 12 of the first member 10. The second upper punch portion 542 has a second lower end surface 542e. The second lower end surface 542e is used to form the outer peripheral surface 22 of the second member 20. The third upper punch portion 543 has a third lower end surface 543e. The third lower end surface 543e is used to form the outer peripheral surface 32 of the third member 30. The first upper punch portion 541, the second upper punch portion 542, and the third upper punch portion 543 may be formed in a connected manner, or may be formed independently of each other so as to be independently movable in the up-down direction. When the first upper punch portion 541, the second upper punch portion 542, and the third upper punch portion 543 are formed in a connected manner, the first lower end surface 541e, the second lower end surface 542e, and the third lower end surface 543e are formed in a connected manner. The first lower end surface 541e has a shape corresponding to the shape of the outer peripheral surface 12 of the first member 10. The second lower end surface 542e has a shape corresponding to the shape of the outer peripheral surface 22 of the second member 20. The third lower end surface 543e has a shape corresponding to the shape of the outer peripheral surface 32 of the third member 30.

When the plurality of grooves 40 are formed in the outer peripheral surface 12 of the first member 10 as illustrated in FIG. 9, it is sufficient that protrusions and recesses corresponding to the plurality of grooves 40 be provided in the first lower end surface 541e of the first upper punch portion 541.

### Lower Punch

The lower punch 55 has a first lower punch portion 551 illustrated in FIG. 11, a second lower punch portion 552 illustrated in FIG. 12, and a third lower punch portion 553 illustrated in FIG. 13. The first lower punch portion 551 has a first upper end surface 551e. The first upper end surface 551e is used to form the inner peripheral surface 13 of the first member 10. The second lower punch portion 552 has a second upper end surface 552e. The second upper end surface 552e is used to form the inner peripheral surface 23 of the second member 20. The third lower punch portion 553 has a third upper end surface 553e. The third upper end surface 553e is used to form the inner peripheral surface 33 of the third member 30. The first lower punch portion 551, the second lower punch portion 552, and the third lower punch portion 553 may be formed in a connected manner or may be formed independently of each other so as to be independently movable in the up-down direction. When the first lower punch portion 551, the second lower punch portion 552, and the third lower punch portion 553 are formed in a connected manner, the first upper end surface 551e, the second upper end surface 552e, and the third upper end surface 553e are formed in a connected manner. The first upper end surface 551e has a shape corresponding to the shape of the inner peripheral surface 13 of the first member 10. The second upper end surface 552e has a shape corresponding to the shape of the inner peripheral surface 23 of the second member 20. The third upper end surface 553e has a shape corresponding to the shape of the inner peripheral surface 33 of the third member 30.

When the plurality of grooves 40 are formed in the inner peripheral surface 13 of the first member 10 as illustrated in FIG. 1, it is sufficient that protrusions and recesses corresponding to the plurality of grooves 40 be provided in the first upper end surface 551e of the first lower punch portion 551.

### Charging Step

The raw material powder is charged into the cavity formed by the die 50 and the lower punch 55. As the raw material powder, the above-described soft magnetic powder or coated soft magnetic powder can be used. In addition to the soft magnetic powder or the coated soft magnetic powder, the raw material powder may include a binder or a lubricant. The lubricant may be applied to the inner peripheral surface of the mold hole 50h of the die 50.

### Molding Step

The raw material powder in the cavity is subjected to compression molding with the upper punch 54 and the lower punch 55. A direction in which the raw material powder is compressed is a direction along the radial direction of the stator core 7. As a pressure in the compression molding increases, the relative density of the core piece 1 to be manufactured increases. For example, the above-described pressure is preferably 700 MPa or higher and more preferably 980 MPa or higher.

### Other Steps

After the molding step, heat treatment may be performed according to need. For example, when distortion is eliminated by the heat treatment, the core piece 1 with low loss can be manufactured. Alternatively, for example, the binder or the lubricant can be removed by the heat treatment. When the raw material powder includes the above-described coated soft magnetic particles, a heat treatment temperature is preferably a temperature at which the insulation coating is decomposed or lower.

The core piece 1 according to the present embodiment can suppress the temperature rise of the coil 80. The core piece 1 has the plurality of grooves 40 in the peripheral surface 11 of the first member 10. The winding 81 is disposed so as to be fitted in the grooves 40. An increase in contact area between the winding 81 and the first member 10 improves the heat dissipation from the winding 81 to the first member 10. The coil 80 is effectively cooled. Furthermore, when the winding 81 is being wound on the first member 10, the winding 81 is held in the grooves 40. Thus, deformation of the winding 81 can be suppressed. Uniformly winding the winding 81 along the grooves 40 improves the space factor of the coil 80. When the space factor of the coil 80 improves, the size of the axial-gap-type rotating electric machine 9 can be reduced and the output of the axial-gap-type rotating electric machine 9 can be increased.

### Modifications

The core piece 1 according to the present embodiment may have a groove 61 or a step 62 in the projection 21 of the second member 20 or the projection 31 of the third member 30 as illustrated in FIG. 14 or 15. In this case, a winding-start end portion 81s of the winding 81 is disposed in the groove 61 or the step 62.

### Modifications 1

In Modification 1, an example in which the projection 21 of the second member 20 has the groove 61 is described with reference to FIG. 14. In this example, the groove 61 is provided in the second end surface 27 in the first projection 211 (see FIG. 3). The groove 61 extends from the outer peripheral surface 22 in the first projection 211 along the peripheral surface 11 of the first member 10. The groove 61 is open in the outer peripheral surface 22. The winding 81 passes through the groove 61 and is wound on the peripheral surface 11. It is sufficient that the groove 61 have a size that allows the winding-start end portion 81s to be contained therein. It is sufficient that the width and the depth of the groove 61 is the diameter of the winding 81 or more.

### Modification 2

In Modification 2, an example in which the projection 21 of the second member 20 has the step 62 is described with reference to FIG. 15. In this example, the projection 21 has a third projection 213 in addition to the first projection 211 and the second projection. 212. The third projection 213 projects in the X2 direction. The step 62 is provided in the third projection 213. The step 62 is concave in the Z1 direction relative to the first projection 211 and the second projection 212. The winding 81 is wound on the peripheral surface 11 from the step 62. In the Z-axis direction, it is sufficient that the distance between the first projection 211 and the step 62 and the distance between the second projection 212 and the step 62 be the diameter of the winding 81 or more.

When the winding-start end portion 81s of the winding 81 is disposed in the above-described groove 61 or the step 62, in winding the winding 81 through multilayered winding, interference of the winding 81 of the second layer and further with the winding-start end portion 81s can be avoided. Thus, compared to a core piece without the groove 61 or the step 62, the number of turns of the winding 81 can be increased by one.

### Embodiment 2

### Stator Core

The stator core 7 according to Embodiment 2 is described with reference to FIG. 16. The stator core 7 according to the present embodiment includes a plurality of core pieces 1 disposed in an annular shape. Each of the plurality of core pieces 1 is the core piece 1 according to Embodiment 1. The plurality of core pieces 1 are combined with each other to form an annular shape such that, out of the core pieces 1 adjacent to each other in the circumferential direction, the step 240 of the first side surface 24a of the second member 20 of a first core piece 1 and the step 240 of the second side surface 24b of the second member 20 of a second core piece 1 are engaged with each other. This stator core 7 is used for the axial-gap-type rotating electric machine 9 in the DS/SR form illustrated in FIG. 18.

In each of the plurality of core pieces 1, variation in length between a surface on a first end portion side and a surface on a second end portion side in the Z-axis direction is preferably 0.1 mm or smaller. The length between the surface on the first end portion side and the surface on the second end portion side in the Z-axis direction is the largest length between the first end surface 26 of the second member 20 and the first end surface 36 of the third member 30.

When the variation in length between the first end surface 26 of the second member 20 and the first end surface 36 of the third member 30 is 0.1 mm or smaller in each of the plurality of core pieces 1, the above-described variation is very small. Accordingly, with the stator core 7, an axial-gap-type rotating electric machine 9 with low noise and low vibration can be configured. The reason for this is as follows. As illustrated in FIG. 18. in the axial-gap-type rotating electric machine 9, each stator 8 and the rotor 90 are disposed so as to face each other. When the variation in length of the stator core 7 is small, variation in space between the stator 8 and the rotor 90 is small. When the above-described variation in space is small, a torque ripple is reduced. When the torque ripple is reduced, neither noise nor vibration is likely to increase. The above-described variation in length is obtained as follows. In each core piece 1, the length between the first end surface 26 of the second member 20 to the first end surface 36 of the third member 30 is measured. This length is the largest length along the Z-axis direction of the core piece 1. The difference between the largest value and the smallest value of the above-described length in each of the plurality of core pieces 1 is calculated. This difference is defined as the variation in length. The variation in length between the first end surface 26 of the second member 20 and the first end surface 36 of the third member 30 in each of the plurality of core pieces 1 is more preferably 0.05 mm or smaller and particularly preferably 0.01 mm or smaller.

In the stator core 7 according to the present embodiment, each of the plurality of core pieces 1 included in the stator core 7 is the core piece 1 according to Embodiment 1. Thus, the temperature rise of the coils 80 can be suppressed.

### Embodiment 3

### Stator

The stator 8 according to Embodiment 3 is described with reference to FIG. 17. The stator 8 according to the present embodiment includes the stator core 7 and coils 80. The stator core 7 according to Embodiment 2 can be used as the stator core 7. The coil 80 is wound on the first member 10 in each core piece 1 of the stator core 7. This stator 8 is used for the axial-gap-type rotating electric machine 9 in the DS/SR form illustrated in FIG. 18.

Each coil 80 includes tubular portion made by winding the winding. In FIG. 17, only the tubular portion of each coil 80 is simplified and illustration of the ends of the winding is omitted. The stator core 7 can be fabricated by winding the winding on the first member 10 of each core piece 1.

Since the stator 8 according to Embodiment 3 includes the stator core 7 according to Embodiment 2, the temperature rise of the coils 80 can be suppressed.

### Embodiment 4

### Rotating Electric Machine

The rotating electric machine 9 according to Embodiment 4 is described with reference to FIG. 18. FIG. 18 is a sectional view taken along a plane that is parallel to a rotating shaft 91 of the rotating electric machine 9 and that passes through the center of the stators 8. This is also applied to FIG. 19 to be referred to in Embodiment 5, which will be described later, in a similar or same manner. The rotating electric machine 9 according to the present embodiment is an axial-gap-type rotating electric machine. The rotating electric machine 9 according to the present embodiment is in the DS/SR form including a single rotor 90 and two stators 8. In the rotating electric machine 9, the rotor 90 and each stator 8 are disposed so as to face each other in the axial direction. The single rotor 90 is mounted so as to be interposed between two stators 8. As each stator 8, the above-described stator 8 according to Embodiment 3 can be used. The rotating electric machine 9 can be used for a motor or a power generator. The rotating electric machine 9 includes a casing 92.

The casing 92 has an inner space having a circular column shape to contain the stators 8 and the rotor 90. The casing 92 includes a cylindrical portion 921 and two plates 922. The cylindrical portion 921 surrounds outer circumferences of the stators 8 and the rotor 90. Each plate 922 is disposed at a corresponding one of the ends of the cylindrical portion 921. Two plates 922 are secured to both end surfaces of the cylindrical portion 921 such that the stators 8 and the rotor 90 are interposed between the plates 922 in the axial direction. Each plate 922 has a through hole at a central portion thereof. A bearing 93 is provided in the through hole. The rotating shaft 91 is inserted through the through hole with the bearing 93 interposed therebetween. The rotating shaft 91 extends through the casing 92.

The rotor 90 includes the magnets 95 and a rotor main body. According to the present embodiment, the rotor 90 is a member having a flat plate shape. A plurality of magnets 95 may be provided as in the present embodiment or, unlike the present embodiment, a single magnet 95 may be provided. When the plurality of magnets 95 are provided, the specific number of the magnets 95 can be the same as the number of core pieces 1. The plurality of magnets 95 are disposed so as to be equally spaced from each other in the circumferential direction of the rotor main body. According to the present embodiment, each magnet 95 has a flat plate shape having a planar shape corresponding to a planar shape of the first end surface 36 of the third member 30 of a corresponding one of the core pieces 1. Each magnet 95 may have a convex lens shape having a convex surface convex toward the stator 8 side. When a single magnet 95 is used, the magnet 95 has an annular shape. In the single magnet 95, the south poles and the north poles are alternately disposed in the circumferential direction. The rotor main body supports the plurality of magnets 95. The rotor main body is an annular-shaped member. The rotor main body is rotatably supported by the rotating shaft 91. The magnets 95 are disposed so as to be equally spaced from each other in the circumferential direction of the rotor main body. Each magnet 95 is magnetized in a direction along the axis of the rotating shaft 91. The magnets 95 adjacent to each other in the circumferential direction of the rotor main body are magnetized in mutually opposite directions. When the magnets 95 and the core pieces 1 repeatedly attract and repel each other due to a rotating magnetic field generated by the stators 8, the rotor 90 rotates.

Each stator 8 is disposed such that the first end surface 36 of the third member 30 in each core piece 1 faces the magnet 95 of the rotor 90. When the rotor 90 rotates, the first end surface 36 of the third member 30 of the core piece 1 receives the magnetic flux from the rotating magnets 95. When the first end surface 36 of the third member 30 in each core piece l has, as illustrated in FIG. 3, a convex shape as described above, noise and vibration of the rotating electric machine 9 can be reduced. The reason for this is as follows. When the first end surface 36 of the third member 30 of each core piece 1 has a convex shape, a steep change of the magnetic flux of the magnets 95 of the rotor 90 received by the core piece 1 is likely to be suppressed. Thus, cogging torque is likely to be reduced. When the cogging torque is reduced, neither noise nor vibration is likely to increase.

Since the rotating electric machine 9 according to Embodiment 4 includes the stators 8 according to Embodiment 3, the temperature rise of the coils 80 can be suppressed.

### Embodiment 5

### Rotating Electric Machine

The rotating electric machine 9 according to Embodiment 5 is described with reference to FIG. 19. The rotating electric machine 9 according to the present embodiment is an axial-gap-type rotating electric machine. The rotating electric machine 9 according to the present embodiment is different from the rotating electric machine 9 according to Embodiment 4 mainly in that the rotating electric machine 9 according to the present embodiment is in the SS/DR form including two rotors 90 and a single stator 8. In the rotating electric machine 9, each rotor 90 and the stator 8 are disposed so as to face each other in the axial direction. The single stator 8 is mounted so as to be interposed between two rotors 90. The following description concentrates on the difference from Embodiment 4. Description of configurations similar to or the same as those of Embodiment 4 is omitted.

Each rotor 90 includes the rotor main body, the plurality of magnets 95, and a back yoke 98. The rotor main body and the plurality of magnets 95 are as in Embodiment 4 described above. The back yoke 98 is provided between the rotor 90 and a corresponding one of the plates 922. The back yoke 98 is a member having a flat plate shape. The back yoke 98 includes a green compact similar to or the same as the above-described core piece 1 or includes a laminated steel sheet.

The stator 8 includes a plurality of core pieces 1 disposed in an annular shape, the coil 80 wound on the first member 10 of each core piece 1, and a support member supporting the plurality of core pieces 1. Illustration of the support member is omitted.

In each core piece 1, the configurations of the second member 20 and the third member 30 are the same as each other. That is, in each core piece 1, projecting amounts of the first projection 211 and the second projection 212 in the second member 20 are the same as projecting amounts of the first projection 311 and the second projection 312 in the third member 30. In the second member 20, the first side surface 24a of the first projection 211 or the second side surface 24b of the second projection 212 does not have the step as described above. The coils 80 are as described in Embodiment 3. The support member holds the plurality of core pieces 1 such that spaces between the adjacent core pieces 1 are equal to each other. With the support member, the core pieces 1 adjacent to each other in the circumferential direction are not in contact with each other.

Since the rotating electric machine 9 according to Embodiment 5 includes the stator 8 similarly to the rotating electric machine 9 according to Embodiment 4, the temperature rise of the coils 80 can be suppressed.

The present invention is not limited to the above-described exemplification but represented by the claims and intended to include all changes in meaning and scope equivalent to the claims. For example, the rotating electric machine can include a single rotor and a single stator.

### Appendices

Relating to the embodiments of the present disclosure having been described, the following appendices are further disclosed.

### Appendix 1

A core piece is
included in a stator core for an axial-gap-type rotating electric machine and includes
a first member that has a column shape and extends in an axial direction of the stator core,
a second member that has a plate shape and is provided at a first end portion in the axial direction in the first member, and
a third member that has a plate shape and is provided at a second end portion in the axial direction in the first member.

The first member has a peripheral surface continuous with the second member and the third member,
the second member has a projection projecting outward relative to the peripheral surface of the first member, and
the third member has a projection projecting outward relative to the peripheral surface of the first member.

Each of the first member, the second member, and the third member includes
an outer peripheral surface disposed at a position far from the axis of the stator core,
an inner peripheral surface disposed at a position close to the axis of the stator core,
a first side surface that is positioned in a first direction of a circumferential direction of the stator core and continuous with the outer peripheral surface and the inner peripheral surface, and
a second side surface that is positioned in a second direction of a circumferential direction of the stator core and continuous with the outer peripheral surface and the inner peripheral surface.

In each of the first member, the second member, and the third member, a length between the first side surface and the second side surface on the outer peripheral surface is larger than a length between the first side surface and the second side surface on the inner peripheral surface.

In each of the first member, the second member, and the third member, the first side surface and the second side surface each include
a first parallel surface continuous with the outer peripheral surface,
a second parallel surface continuous with the inner peripheral surface, and
a first inclined surface continuous with the first parallel surface and the second parallel surface.

In each of the first member, the second member, and the third member,
the first parallel surface of the first side surface and the first parallel surface of the second side surface are parallel to each other,
the second parallel surface of the first side surface and the second parallel surface of the second side surface are parallel to each other, and
the first parallel surface of the first side surface and the second parallel surface of the first side surface are parallel to each other.

The first member, the second member, and the third member include an integrally molded green compact.

The peripheral surface of the first member has a plurality of grooves in at least part of a surface in contact with a winding of a coil. The plurality of grooves are provided along a direction in which the winding is wound.

The core piece according to appendix 1 is manufactured with high productivity.

The related-art core piece is made by, for example, combining a green compact obtained by integrally molding a first member and a second member with a third member made separately from the green compact. Alternatively, the related-art core piece is made by, for example, combining a green compact obtained by integrally molding the first member and the third member with the second member made separately from the green compact. That is, to make the related-art core piece, it is necessary to fabricate at least two members and combine the fabricated members with each other. Thus, the number of steps necessary for the manufacture of the related-art core piece is large, and manufacturing time is long. Furthermore, at least two molds are necessary for the manufacture of the related-art core piece.

In contrast, the core piece according to appendix 1 includes a green compact obtained by integrally molding the first member, the second member, and the third member. Thus, it is not necessary to combine a plurality of members together. Accordingly, compared to the related-art core piece, the core piece according to appendix 1 can be manufactured in a smaller number of steps and a shorter time. Furthermore, the core piece according to appendix 1 includes the green compact obtained by integrally molding the first member, the second member, and the third member. Thus, the core piece according to appendix 1 can be manufactured with a single mold. This allows reduction of expenses necessary for fabrication, maintenance, and the like of the mold, and accordingly, the core piece according to appendix 1 can be manufactured at a low cost.

The green compact is manufactured by compression molding a raw material powder charged into a mold hole of a die of the mold with an upper punch and a lower punch. The green compact obtained by integrally molding the first member, the second member, and the third member can be manufactured by aligning a pressure applying direction and a removal direction with a direction along a radial direction of the stator core as described in the method of manufacturing above. Out of the core piece, the outer peripheral surface and the inner peripheral surface are formed with a lower end surface of the upper punch and an upper end surface of the lower punch. Out of the core piece, the first and second side surfaces and the first and second end surfaces in the axial direction of the stator core are formed with an inner peripheral surface of the mold hole of the die. In this case, even when the second member and the third member each have the projection, the projection is not caught by the inner peripheral surface of the mold hole of the die. Thus, the core piece can be removed from the mold.

Furthermore, the core piece according to appendix 1 has a high relative density. The reason for this is as follows. As described above, the first parallel surface and the second parallel surface can be formed with straight portions along the pressure applying direction of the upper punch and the lower punch in the mold hole of the die of the mold. Thus, the pressure can be sufficiently applied to raw material powder to be formed into the core piece 1. In addition, the first inclined surfaces can be formed with a tapered portion intersecting the pressure applying direction of the upper punch and the lower punch in the mold hole of the die of the mold. When the mold hole of the die has the straight portions, contact of the upper punch and the lower punch with an inner peripheral surface of the tapered portion is suppressed. This increases life of the mold, and accordingly, the number of core pieces that can be produced by a single mold increases.

### Appendix 2

In the core piece according to appendix 1,
in each of the first member, the second member, and the third member,
   an angle formed between an extended plane of the first parallel surface of the first side surface and the first inclined surface of the first side surface is 5° to 20°, and
   an angle formed between an extended plane of the first parallel surface of the second side surface and the first inclined surface of the second side surface is 5° to 20°.

In the core piece according to appendix 2, the above-described angles in the first member satisfy the above-described range. This facilitates winding of the winding on the peripheral surface of the first member and a configuration of a stator. In the core piece according to appendix 2, the above-described angles in the second member satisfy the above-described range. This facilitates disposition in an annular shape and building of the stator core. In the core piece according to appendix 2, the above-described angles in the third member satisfy the above-described range. Thus, variation in density of the core piece can be suppressed.

### Appendix 3

In the core piece according to appendix 1 or 2,
each of the projection of the second member and the projection of the third member has
a first projection projecting in the first direction of the circumferential direction, and
a second projection projecting in the second direction of the circumferential direction.

A projecting amount of the first projection in the second member is larger than a projection amount of the first projection in the third member.

A projecting amount of the second projection in the second member is larger than a projection amount of the second projection in the third member.

The first inclined surface of the first projection in the second member has a projecting part projecting outward relative to a first virtual plane.

The first inclined surface of the second projection in the second member has a projecting part projecting outward relative to a second virtual plane.

The first virtual plane is a plane connecting a connecting portion between the first parallel surface and the first inclined surface to a connecting portion between the second parallel surface and the inner peripheral surface in the first side surface of the first projection in the second member.

The second virtual plane is a plane connecting a connecting portion between the first parallel surface and the first inclined surface to a connecting portion between the second parallel surface and the inner peripheral surface in the second side surface of the second projection in the second member.

The core piece according to appendix 3 facilitates configuration of the stator core having a large magnetic path area. The reason for this is as follows.

The stator core is configured such that a plurality of core pieces are disposed in an annular shape. A subset of stator cores are made by combining a first core piece and a second core piece adjacent to each other in the circumferential direction with each other so as to be in contact with each other.

For example, in the case of the core pieces in each of which the first side surface of the first projection and the second side surface of the second projection each have the first parallel surface, the second parallel surface, and the first inclined surface, and the first inclined surface has no projecting part, the following situation occurs. In disposing the core pieces in an annular shape, when it is attempted to bring the first side surface of the first projection in the second member of the first core piece and the second side surface of the second projection in the second member of the second core piece into contact with each other, a first comer portion of the first core piece and a second corner portion of the second core piece are brought into contact with each other. The first comer portion is a comer portion between the first side surface of the first projection and the inner peripheral surface in the second member. The second comer portion is a comer portion between the second side surface of the second projection and the inner peripheral surface in the second member. Thus, sufficient contact is not achieved between the first side surface of the first projection in the second member of the first core piece and the second side surface of the second projection in the second member of the second core piece.

In contrast, in the core piece according to appendix 3, the first side surface of the first projection and the second side surface of the second projection each have the first parallel surface, the second parallel surface, and the first inclined surface, and the first inclined surface has a projecting part projecting relative to a corresponding one of the first virtual plane and the second virtual plane. In disposing the core pieces in an annular shape, even when the first side surface of the first projection in the second member of the first core piece and the second side surface of the second projection in the second member of the second core piece are brought into contact with each other, contact between the first corner portion of the first core piece and the second corner portion of the second core piece can be prevented. Thus, sufficient contact is achieved between the first side surface of the first projection in the second member of the first core piece and the second side surface of the second projection in the second member of the second core piece.

### Appendix 4

In the core piece according to appendix 3,
the first side surface of the first projection in the second member has one selected from the group consisting of at least one of a recess and a protrusion, a step, and a second inclined surface.

The second side surface of the second projection in the second member bas one selected from the group consisting of at least one of a protrusion corresponding to the recess of the first side surface and a recess corresponding to the protrusion of the first side surface, a step corresponding to the step of the first side surface, and a second inclined surface corresponding to the second inclined surface of the first side surface.

The core piece according to appendix 4 facilitates the configuration of the stator core having a large magnetic path area. The reason for this is as follows. The first core piece and the second core piece adjacent to each other in the circumferential direction of the stator core can be engaged with each other at the steps or the recess/protrusion or in contact with each other at the second inclined surfaces. Thus, the first core piece and the second core piece can be in sufficient contact with each other. This can increase a contact area between the first core piece and the second core piece.

### Appendix 5

In the core piece according to appendix 3 or 4,
the third member has a first end surface disposed on an opposite side from a side facing the second member, and
the first end surface is provided so as to be convex toward the opposite side.

With the core piece according to appendix 5, the rotating electric machine with low noise and low vibration can be build. The reason for this is as follows. In the rotating electric machine, the stator and the rotor are disposed so as to face each other. The stator is configured such that the coil is disposed in each first member of the stator core. The stator core is configured such that the plurality of core pieces are disposed in an annular shape. When the first end surface of the core piece has a convex shape, a steep change of a magnetic flux of magnets of the rotor received by the core piece is likely to be suppressed. When the steep change of the magnetic flux is likely to be suppressed, the cogging torque is likely to be reduced. When the cogging torque is reduced, neither noise nor vibration is likely to increase.

### Appendix 6

In the core piece according to any one of appendices 1 to 5,
the outer peripheral surface of each of the first member, the second member, and the third member has a curved surface convex in a direction separating from the axis of the stator core.

The inner peripheral surface of each of the first member, the second member, and the third member has a curved surface convex in a direction approaching the axis of the stator core.

The core piece according to appendix 6 can suppress variation in density of the core piece.

### Appendix 7

In the core piece according to any one of appendices 1 to 6,
a first joint between the projection of the second member and the peripheral surface of the first member and a second joint between the projection of the third member and the peripheral surface of the first member are rounded.

In the core piece according to appendix 7, the first joint and the second joint are rounded. Thus, the core piece is unlikely to be subjected to damage caused with the joints as starting points.

### Appendix 8

In the core piece according to appendix 7,
a bending radius of the first joint and a bending radius of the second joint are 0.2 mm to 4.0 mm.

The bending radii of the first joint and the second joint are 0.2 mm or larger in the core piece according to appendix 8. Thus, load applied to the mold in the manufacture of the core piece can be reduced. The bending radii of the first joint and the second joint are 4.0 mm or smaller in the core piece according to appendix 8. Thus, winding of the coil is facilitated in configuring the stator, and accordingly, an increase in the number of turns of the coil is facilitated.

### Appendix 9

In the core piece according to any one of appendices 1 to 8, the second member and the third member have respective first end surfaces, the first end surface of the second member is disposed on an opposite side from a side facing the third member, and the first end surface of the third member is disposed on an opposite side from a side facing the second member.

In each of the second member and the third member, a corner portion between the outer peripheral surface and the first end surface and a corner portion between the inner peripheral surface and the first end surface are chamfered.

In the core piece according to appendix 9, the above-described comer portions are chamfered, and accordingly, the corner portions are unlikely to be damaged.

### Appendix 10

In the core piece according to any one of appendices 1 to 9,

The total area of the outer peripheral surfaces in the first member, the second member, and the third member is larger than the total area of the inner peripheral surfaces in the first member, the second member, and third member and four times the total area of the inner peripheral surfaces or smaller.

The total area of the outer peripheral surfaces is larger than the total area of the inner peripheral surfaces in core piece according to appendix 10. This facilitates disposition in an annular shape and the configuration of the stator core. In the above-described core piece, the total area of the outer peripheral surfaces is four times the total area of the inner peripheral surfaces or smaller. This facilitates the manufacture of the above-described core piece. When the ratio of the total area of the inner peripheral surfaces is comparatively large, the area by which the core piece is pushed out by the lower punch is large during removal of the core piece from the mold. Thus, damage to the core piece is likely to be suppressed during the removal of the core piece from the mold.

### Appendix 11

In the core piece according to any one of appendices 1 to 10,

Out of three portions of the core piece divided by a virtual plane along the second parallel surface of the first side surface and a virtual plane along the second parallel surface of the second side surface, a difference in relative density between a first portion positioned in the first direction of the circumferential direction and a third portion positioned between the first portion and a second portion positioned in the second direction of the circumferential direction and a difference in relative density between the second portion and the third portion are 5.0% or smaller.

Since the difference in relative density of the core piece according to appendix 11 is small, the physical characteristics such as the magnetic characteristics are substantially uniform in the core piece.

### Appendix 12

In the core piece according to any one of appendices 1 to 11, among the first member, the second member, and the third member, the difference in relative density between a member with a highest relative density and a member with a lowest relative density is preferably 5.0% or smaller.

Since the difference in relative density of the core piece according to appendix 12 is small, the physical characteristics such as the magnetic characteristics are substantially uniform in the core piece.

### Appendix 13

In the core piece according to any one of appendices 1 to 12, the relative density of the green compact is 85% or higher.

Since the relative density of the core piece according to appendix 13 is 85% or higher, the core piece according to appendix 13 has a high density. With the core piece according to appendix 13, the axial-gap-type rotating electric machine having good magnetic characteristics such as saturation flux density can be built. In addition, the core piece according to appendix 13 has good mechanical characteristics such as strength.

### Appendix 14

In the core piece according to any one of appendices 1 to 13, the green compact is formed of an aggregation of a plurality of coated soft magnetic particles having insulation coating on surfaces of soft magnetic particles, and the soft magnetic particles are iron particles consisting of at least one metal selected from the group consisting of pure iron, an Fe-Si alloy, an Fe-Al alloy, and an Fe-Si-Al alloy.

The core piece according to appendix 14 is a high-density core piece with high dimensional accuracy. The reason for this is that, since the above-described material is comparatively soft, the soft magnetic particles is likely to deform when the green compact is molded.

### REFERENCE SIGNS LIST

1 core piece
10 first member
11 peripheral surface, 12 outer peripheral surface, 13 inner peripheral surface
14a first side surface, 14b second side surface
141 first parallel surface, 142 second parallel surface, 143 first inclined surface
20 second member
21 projection
211 first projection, 212 second projection, 213 third projection
22 outer peripheral surface, 23 inner peripheral surface, 24a first side surface,
24b second side surface
240 step
241 first parallel surface, 242 second parallel surface, 243 first inclined surface
244 projecting part
26 first end surface, 27 second end surface
30 third member
31 projection, 311 first projection, 312 second projection
32 outer peripheral surface, 33 inner peripheral surface
34 a first side surface, 34b second side surface
341 first parallel surface, 342 second parallel surface, 343 first inclined surface
36 first end surface, 37 second end surface
40 groove
40w width, 40d depth
42 coupling surface
5 mold
50 die, 50h mold hole
51 first hole portion
511 first straight portion, 512 second straight portion, 513 tapered portion
52 second hole portion
521 first straight portion, 522 second straight portion, 523 tapered portion
53 third hole portion
531 first straight portion, 532 second straight portion, 533 tapered portion
54 upper punch
541 first upper punch portion, 541e first lower end surface
542 second upper punch portion, 542e second lower end surface
543 third upper punch portion, 543e third lower end surface
55 lower punch
551 first lower punch portion, 551e first upper end surface
552 second lower punch portion, 552e second upper end surface
553 third lower punch portion, 553e third upper end surface
61 groove, 62 step
7 stator core, 8 stator
80 coil
81 winding, 81s winding-start end portion
81a long diameter, 81b short diameter
81d diameter
9 rotating electric machine
90 rotor, 91 rotating shaft, 92 casing
921 cylindrical portion, 922 plate
93 bearing, 95 magnet, 98 back yoke
E11, E12, E21, E22, E31, E32 extended plane
Va, Vb virtual plane, V21 first virtual plane, V22 second virtual plane
θ11, θ21, θ31 first inclination angle
θ12, θ22, θ32 second inclination angle

1. A core piece,
wherein the core piece is included in a stator core for an axial-gap-type rotating electric machine, the core piece including
a first member having a column shape, the first member extending in a direction along an axis of the stator core, and
wherein a peripheral surface of the first member has a plurality of grooves in at least part of a surface in contact with a winding of a coil, the plurality of grooves being provided along a direction of winding the winding.

2. The core piece according to claim 1,
wherein a width of each of the plurality of grooves is ¼ of a long diameter of the winding to the long diameter, and
a depth of each of the plurality of grooves is ¼ of a short diameter of the winding to the short diameter.

3. The core piece according to claim 1,
wherein a section of the winding has a circular shape,
a section of each of the plurality of grooves has an arc shape, and
a radius of a circle of the section of the winding and a radius of an arc of the section of the groove are identical to each other.

4. The core piece according to claim 1,
wherein the plurality of grooves include a coupling surface between two of the grooves adjacent to each other, the coupling surface being continuous with inner peripheral surfaces of the grooves, and
the coupling surface is a flat surface or a rounded curved surface.

5. The core piece according to claim 1,
wherein the peripheral surface includes
an inner peripheral surface disposed at a position close to the axis of the stator core, and
an outer peripheral surface disposed at a position far from the axis of the stator core, and
wherein the plurality of grooves are provided in at least one of the inner peripheral surface and the outer peripheral surface.

6. The core piece according to claim 1, further comprising:
a second member having a plate shape, the second member being provided at a first end portion in the direction along the axis in the first member; and
a third member having a plate shape, the third member being provided at a second end portion in the direction along the axis in the first member;
wherein the peripheral surface of the first member is continuous with the second member and the third member,
wherein the second member has a projection projecting outward relative to the peripheral surface of the first member, and
the third member has a projection projecting outward relative to the peripheral surface of the first member, and
wherein the first member, the second member, and the third member includes an integrally molded green compact.

7. The core piece according to claim 6,
wherein the projection of the second member or the projection of the third member has a groove or a step, a winding-start end portion of the winding being disposed in the groove or the step.

8. A core piece,
wherein the core piece is included in a stator core for an axial-gap-type rotating electric machine, the core piece including
a first member having a column shape, the first member extending in a direction along an axis of the stator core;
a second member having a plate shape, the second member being provided at a first end portion in the direction along the axis in the first member; and
a third member having a plate shape, the third member being provided at a second end portion in the direction along the axis in the first member,
wherein the first member has a peripheral surface continuous with the second member and the third member,
the second member has a projection projecting outward relative to the peripheral surface of the first member, and
the third member has a projection projecting outward relative to the peripheral surface of the first member,
wherein the first member, the second member, and the third member includes an integrally molded green compact,
wherein the peripheral surface of the first member includes
an inner peripheral surface disposed at a position close to the axis of the stator core, and
an outer peripheral surface disposed at a position far from the axis of the stator core,
wherein, in at least one of the inner peripheral surface and the outer peripheral surface, a plurality of grooves are provided in at least a part of a surface in contact with a winding of a coil, the plurality of grooves being provided along a direction of winding the winding,
wherein a width of each of the plurality of grooves is ¼ of a long diameter of the winding to the long diameter, and
a depth of each of the plurality of grooves is ¼ of a short diameter of the winding to the short diameter, and
wherein the projection of the second member or the projection of the third member has a groove or a step, a winding-start end portion of the winding being disposed in the groove or the step.

9. A stator core,
wherein the stator core is for an axial-gap-type rotating electric machine, the stator core including
a plurality of core pieces disposed in an annular shape, and
wherein each of the plurality of core pieces is the core piece according to claim 1.

10. A stator,
wherein the stator is for an axial-gap-type rotating electric machine, the stator including
the stator core according to claim 9; and
a coil disposed in each of the first members in the stator core.

11. A rotating electric machine,
wherein the rotating electric machine is an axial-gap-type rotating electric machine including
a rotor and a stator, wherein the rotor and the stator are disposed so as to face each other in a direction along an axis, and
wherein the stator is the stator according to claim 10.

12. A stator core,
wherein the stator core is for an axial-gap-type rotating electric machine, the stator core including
a plurality of core pieces disposed in an annular shape, and
wherein each of the plurality of core pieces is the core piece according to claim 8.

13. A stator,
wherein the stator is for an axial-gap-type rotating electric machine, the stator including
the stator core according to claim 12; and
a coil disposed in each of the first members in the stator core.

14. A rotating electric machine,
wherein the rotating electric machine is an axial-gap-type rotating electric machine including
a rotor and a stator, wherein the rotor and the stator are disposed so as to face each other in a direction along an axis, and
wherein the stator is the stator according to claim 13.
